(19) United States
(12) Patent Application Publication
(10) Pub. No.: US 2005/0195943 A1
(43) Pub. Date: Sep. 8, 2005

(54) Method of forming subtraction images

(75) Inventor: Satoshi Arakawa, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/630,930

(22) Filed: Jul. 31, 2003

(30) Foreign Application Priority Data
Jul. 31, 2002 (JP) 223232/2002

(51) Int. Cl. H05G 1/64

(52) U.S. Cl. 378/98.11

(57) ABSTRACT

A radiation image signal is acquired from a radiation image of an object before being injected with a contrast medium, and a radiation image signal is acquired from a radiation image of the same object after being injected with the contrast medium. A subtraction process for subtracting image signal components of a plurality of the thus acquired radiation image signals, which image signal components represent corresponding pixels in the radiation images represented by the plurality of the radiation image signals, from one another is performed. A contrasted radiation image, in which a pattern of a specific structure of the object having been contrasted with the contrast medium in the radiation image has been extracted or enhanced, is thus formed. The contrast medium is a liposome, which contains a hydrophobic iodine compound as a film forming constituent.

### BACKGROUND OF THE INVENTION

1. Field of the Invention

This invention relates to a method of forming a subtraction image, wherein a contrasted radiation image is obtained by use of a contrast medium.

2. Description of the Related Art

Techniques for photoelectrically reading out a radiation image, which has been recorded on a photographic film, in order to obtain an image signal, carrying out appropriate image processing on the image signal, and then reproducing a visible image by use of the processed image signal have heretofore been known in various fields. For example, an X-ray image is recorded on an X-ray film having a small gamma value chosen according to the type of image processing to be carried out, and the X-ray image is photoelectrically read out from the X-ray film, an electric signal (i.e., an image signal) being thereby obtained. The image signal is converted into a digital image signal. The digital image signal is then processed and used for reproducing the X-ray image as a visible image on a photocopy, or the like. In this manner, a visible image having good image quality with high contrast, high sharpness, high graininess, or the like, is capable of being reproduced.

Also, it has been proposed to use stimulable phosphors in radiation image recording and reproducing systems. Specifically, a radiation image of an object, such as a human body, is recorded on a sheet provided with a layer of the stimulable phosphor (hereinafter referred to as a stimulable phosphor sheet). The stimulable phosphor sheet, on which the radiation image has been stored, is then exposed to stimulating rays, such as a laser beam, which cause the stimulable phosphor sheet to emit light in proportion to the amount of energy stored thereon during its exposure to the radiation. The light emitted by the stimulable phosphor sheet, upon stimulation thereof, is photoelectrically detected and converted into an electric image signal. The image signal is then processed and used for the reproduction of the radiation image of the object as a visible image on a recording material.

Further, various methods and apparatuses for recording and reading out radiation image information by utilizing solid-state radiation detectors (electrostatic recording materials) as image detectors have heretofore been proposed. With the proposed methods and apparatuses for recording and reading out radiation image information, electric charges, which have been acquired by detection of radiation, such as X-rays, are accumulated as latent image electric charges in a charge accumulating section, which is formed within the solid-state radiation detector. Also, the thus accumulated latent image electric charges are converted by the solid-state radiation detector into an electric signal representing the radiation image information. The methods and apparatuses for recording and reading out radiation image information by utilizing image detectors are described in, for example, U.S. Pat. No. 5,268,569, PCT International Publication No. WO 98/59261, Japanese Unexamined Patent Publication No. 9(1997)-5906, and Japanese Patent Application Nos. 10(1998)-232824, 10(1998)-271374, and 11(1999)-87922.

In the radiation image recording and reproducing systems wherein recording media, such as X-ray film, stimulable phosphor sheets, or solid-state radiation detectors, are used, a temporal (time difference) subtraction processing technique utilizing a contrast medium is often carried out. With the temporal subtraction processing technique, a radiation image of an object, which has not been injected with the contrast medium, is subtracted from a radiation image of the same object having been injected with the contrast medium, in which radiation image a pattern of a specific structure or part of the object (e.g., a pattern of a blood vessel, or the like, in cases where the object is a human body) has been enhanced by the injection of the contrast medium. With the subtraction process, the pattern of the specific structure or part of the object (e.g., the pattern of the blood vessel) is extracted. In this manner, a temporal subtraction image (a contrasted radiation image), in which the pattern of the specific structure or part of the object having been contrasted with the contrast medium has been extracted or enhanced, is formed.

With subtraction processing techniques for radiation images, an image is obtained which corresponds to a difference between a plurality of radiation images of an object recorded under different conditions. Specifically, a plurality of the radiation images recorded under different conditions are read out at predetermined sampling intervals, and a plurality of image signals thus detected are converted into digital image signals which represent the radiation images. The image signal components of the digital image signals, which components represent the image information recorded at corresponding sampling points (i.e., pixels) in the radiation images, are then subtracted from each other. A difference signal is thereby obtained which represents the image of a specific structure or part of the object (hereinbelow also referred to as the pattern of a tissue, a structure, or the like) represented by the radiation images.

Since the contrast medium described above is injected into the human body, the amount of the contrast medium injected should be as small as possible. However, in cases where the amount of the contrast medium injected is small, the problems occur in that the contrast of the pattern formed with the contrast medium becomes lower than the contrast of a pattern of an anatomical structure of the object, and therefore perceptibility of the pattern formed with the contrast medium becomes bad. However, with the temporal subtraction processing technique performed in the manner described above, in cases where the amount of the contrast medium injected is small, a contrasted radiation image having high contrast is capable of being obtained.

As the contrast media for X-ray angiography, water-soluble iodine contrast media have heretofore been utilized. X-ray angiographic images obtained by use of the water-soluble iodine contrast media have heretofore been utilized for diagnoses of an arteriosclerosis, and the like. However, with the techniques utilizing the water-soluble iodine contrast media, ordinarily, only the focuses, at which stenosis has advanced by at least 50%, are capable of being detected, and it is not always possible to detect the focuses before the patients have a paroxysm of an ischemic disease (e.g., a heart disease, such as myocardial infarction or angina pectoris, or a cerebral blood vessel disease, such as cerebral infarction or cerebral hemorrhage). Accordingly, there is a strong demand for a technique, with which the ischemic disease is capable of being diagnosed at an earlier stage of the disease.

Also, there have been reported various attempts for forming a preparation of a hydrophobic iodine contrast medium or a hydrophilic contrast medium and causing the contrast medium to accumulate selectively at a desired diseased part. (The attempts are described in, for example, PCT International Publication Nos. WO 95/19186, WO 95/21631, WO 89/00812, WO 96/00089, WO 94/19025, WO 96/40615, WO 95/2295, WO 98/41239, WO 98/23297, WO 99/02193, and WO 97/06132, British Patent No. 867,650, U.S. Pat. Nos. 4,192,859, 4,567,034, and 4,925,649, Pharm. Res., 16(3), 420 (1999), J. Pharm. Sci., 72(8), 898 (1983), and Invest. Radiol., 18(3), 275 (1983).) For example, in Pharm. Res., 16(3), 420 (1999), it has been disclosed that an oil droplet dispersion of cholesteryl iopanoate, which is a hydrophobic compound, is injected into a test animal, and the iodine compound is thereby accumulated at an arteriosclerosis part of the test animal.

Further, in J. Pharm. Sci., 72(8), 898 (1983), an example of X-ray contrasting of the liver or the spleen by the injection of an oil droplet dispersion of cholesteryl iopanoate has been disclosed. Furthermore, in U.S. Pat. No. 4,567,034, a method of encapsulating an ester product of diatrizoic acid in a liposome and performing selective contrasting of the liver or the spleen has been reported. Also, in PCT International Publication Nos. WO 96/28414 and WO 96/00089, contrast media for imaging a blood vessel pool or a lymph system have been disclosed.

However, with the techniques for forming the preparations described above, a sufficient efficiency and a sufficient selectivity cannot be obtained for the purposes of selectively contrasting a blood vessel disease. Also, any example has not been reported as to the imaging of a blood vessel disease by irradiation of X-rays.

Accordingly, the applicant proposed means for selectively accumulating an iodine compound at, for example, a blood vessel diseased part due to an arteriosclerosis or abnormal growth of a blood vessel smooth muscle, such as re-stenosis after PTCA, in Japanese Patent Application Nos. 2001-018573, 2001-126475, and 2001-126476.

### SUMMARY OF THE INVENTION

The primary object of the present invention is to provide a method of forming a subtraction image, wherein a contrasted radiation image is capable of being obtained such that a focus at an early stage is capable of being detected.

The present invention provides a method of forming a subtraction image, comprising the steps of:
i) acquiring a radiation image signal from a radiation image of an object before being injected with a contrast medium, the radiation image signal being made up of a series of image signal components,
ii) acquiring a radiation image signal from a radiation image of the same object after being injected with the contrast medium, the radiation image signal being made up of a series of image signal components, and
iii) performing a subtraction process for subtracting the image signal components of a plurality of the thus acquired radiation image signals, which image signal components represent corresponding pixels in the radiation images represented by the plurality of the radiation image signals, from one another, whereby a contrasted radiation image, in which a pattern of a specific structure of the object having been contrasted with the contrast medium in the radiation image has been extracted or enhanced, is formed,
wherein the contrast medium is a liposome, which contains a hydrophobic iodine compound as a film forming constituent.

Specifically, the present invention provides a method of forming a subtraction image with the so-called temporal subtraction processing technique, wherein the liposome, which contains the hydrophobic iodine compound as the film forming constituent, is employed as the contrast medium, and the contrasted radiation image, in which the pattern of the specific structure having been contrasted by use of the contrast medium has been extracted or enhanced, is obtained.

The method of forming a subtraction image in accordance with the present invention should preferably be modified such that the hydrophobic iodine compound is a 1,3,5-triiodobenzene derivative having at least one substituent group having at least 18 carbon atoms.

Also, the method of forming a subtraction image in accordance with the present invention should preferably be modified such that the liposome contains at least one lipid, which is selected from the group consisting of a phosphatidyl choline and a phosphatidyl serine, as a film forming constituent.

Further, the method of forming a subtraction image in accordance with the present invention should preferably be modified such that the liposome contains a phosphoric acid dialkyl ester, which is a diester of an alkyl having at least six carbon atoms, as a film forming constituent.

Furthermore, the method of forming a subtraction image in accordance with the present invention should preferably be modified such that the hydrophobic iodine compound has a residue of a cholesterol derivative as a substituent group having at least 18 carbon atoms.

At the time of the operations for recording the radiation images of the object to be subjected to the temporal subtraction processing, periodical motion of the site of the object, the images of which site are to be recorded, should preferably be detected, and each of the radiation images should preferably be recorded with a timing synchronized with the definite timing of the motion of the site of the object, the images of which site are to be recorded. The synchronization of the timings may be performed with a technique described in, for example, Japanese Unexamined Patent Publication No. 2000-189413.

Also, before the subtraction process is performed on the radiation image of the object before being injected with the contrast medium and the radiation image of the object after being injected with the contrast medium, position matching should preferably be performed on the radiation images. The position matching may be performed with a technique described in, for example, Japanese Unexamined Patent Publication No. 58(1983)-16333, wherein patterns of markers acting as reference positions are recorded simultaneously with the recording of each of the radiation images, and the positions of the patterns of the markers having been recorded in one of the radiation image and the positions of the patterns of the markers having been recorded in the other radiation image are matched with each other. Alternatively, the position matching may be performed with a technique described in, for example, Japanese Unexamined Patent Publication No. 2001-325584, wherein a structural corresponding position relationship of a specific structure is calculated, and the positions of the radiation images are matched with each other in accordance with the structural corresponding position relationship having been calculated.

With the method of forming a subtraction image in accordance with the present invention, wherein the contrasted radiation image is formed with the so-called temporal subtraction processing technique, the liposome, which contains the hydrophobic iodine compound as the film forming constituent, is employed as the contrast medium. The liposome selectively accumulates in a blood vessel smooth muscle and a foamed macrophage, which are principal constituents of an arteriosclerosis focus. Therefore, with the method of forming a subtraction image in accordance with the present invention, the contrasted radiation image, in which a blood vessel diseased part has been contrasted selectively, is capable of being obtained. Accordingly, a blood vessel disease is capable of being detected and diagnosed at its early stage:

### BRIEF DESCRIPTION OF THE DRAWINGS

FIG. 1 is a schematic view showing a radiation image recording apparatus,

FIG. 2 is a perspective view showing a radiation image read-out apparatus and an image processing and displaying apparatus, and

FIG. 3 is an explanatory view showing radiation images, which are to be subjected to subtraction process, and a subtraction image, which is obtained from the subtraction process.

### DESCRIPTION OF THE PREFERRED EMBODIMENTS

The present invention will hereinbelow be described in further detail with reference to the accompanying drawings.

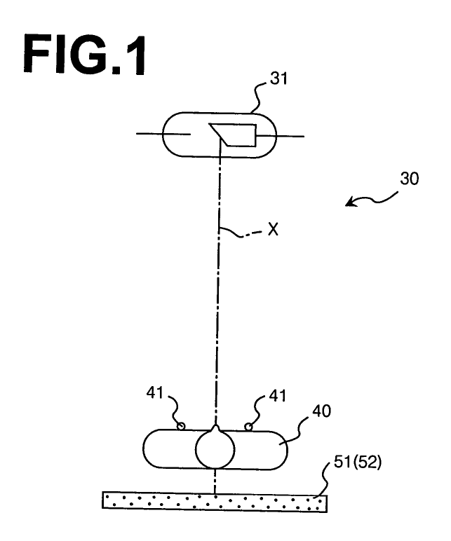

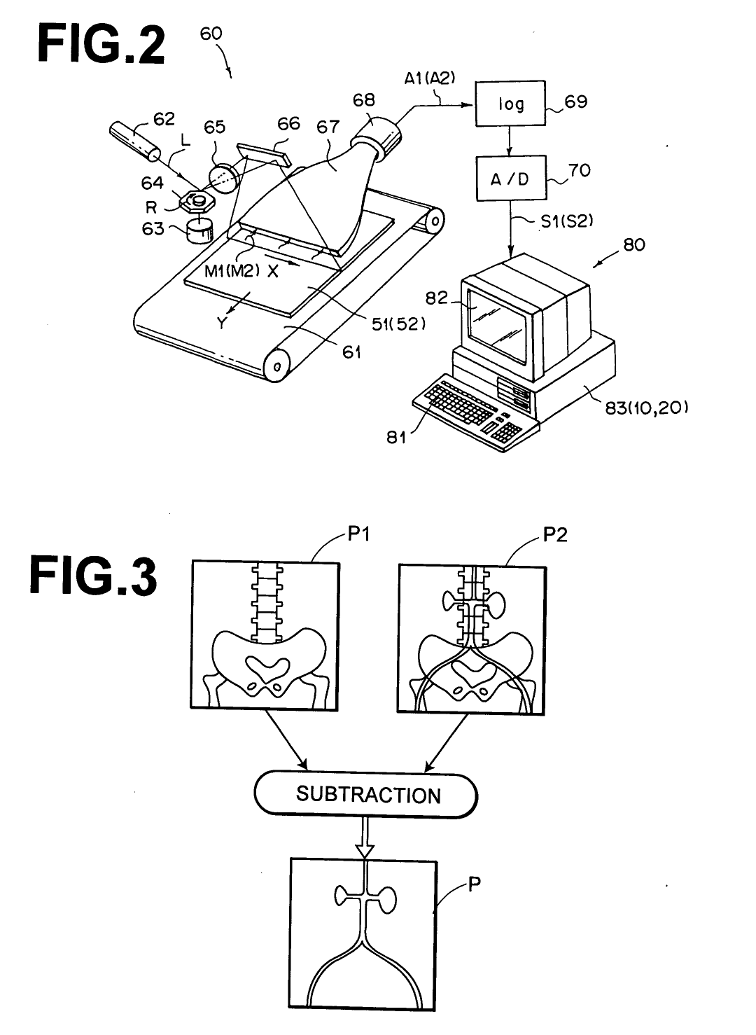

FIG. 1 is a schematic view showing a radiation image recording apparatus. FIG. 2 is a perspective view showing a radiation image read-out apparatus and an image processing and displaying apparatus, which is provided with temporal subtraction processing means and image processing means.

The method of forming a subtraction image in accordance with the present invention is characterized by using a liposome, which contains a hydrophobic iodine compound, as a contrast medium for contrasting a specific site of an object. It has been known that, in the cases of a blood vessel disease, such as an arteriosclerosis or re-stenosis after PTCA, cells of a blood vessel smooth muscle, which constitute a middle membrane of a blood vessel, grow abnormally and simultaneously migrate into an inner membrane of the blood vessel, and the blood flow path thus becomes narrow. Though a trigger causing normal cells of the blood vessel smooth muscle to begin abnormal growth has not yet been clarified, it has been known that the migration of a macrophage into the inner membrane of the blood vessel and the foaming of the macrophage are important factors. Also, it has been reported that the cells of the blood vessel smooth muscle thereafter undergo a phenotypic conversion (conversion from a contraction type to a synthetic type). In cases where the liposome containing the hydrophobic iodine compound is used, the hydrophobic iodine compound is capable of being taken selectively into the blood vessel smooth muscle, which has grown abnormally due to the effects of the foamed macrophage. Therefore, the focus of the blood vessel disease is capable of being contrasted selectively.

As illustrated in FIG. 1, with a radiation image recording apparatus 30, an X-ray image of an object 40 before being injected with the blood vessel contrast medium is recorded on a first stimulable phosphor sheet 51. Thereafter, the contrast medium is injected into a vein of the same object 40. When a predetermined period of time has then elapsed, an X-ray image of the object after being injected with the contrast medium is recorded on a second stimulable phosphor sheet 52. In the operations for recording the radiation images on the first stimulable phosphor sheet 51 and the second stimulable phosphor sheet 52, a tube voltage of an X-ray source 31 is kept to be identical. Also, the relationship between the position of the object 40 and the position of the first stimulable phosphor sheet 51 and the relationship between the position of the object 40 and the position of the second stimulable phosphor sheet 52 are kept to be identical. In this manner, the two X-ray images are recorded respectively on the first stimulable phosphor sheet 51 and the second stimulable phosphor sheet 52, such that there is no difference between the two X-ray images, except for the presence or absence of the contrast medium. As described above, as the contrast medium, the liposome containing the hydrophobic iodine compound is utilized.

Two marks 41, 41, whose positions act as reference positions for position matching between two radiation images P1 and P2 prior to a subtraction process, are attached to the object 40. Together with the image of the object 40, patterns of the marks 41, 41 are recorded on each of the first stimulable phosphor sheet 51 and the second stimulable phosphor sheet 52. Also, in accordance with the positions of the patterns of the marks 41, 41 in the radiation image P1, which has been stored on the first stimulable phosphor sheet 51, and the positions of the patterns of the marks 41, 41 in the radiation image P2, which has been stored on the second stimulable phosphor sheet 52, a shift between a pattern of a specific structure of the object 40 in the radiation image P1 and a pattern of the specific structure of the object 40 in the radiation image P2 is compensated for by use of a technique described in, for example, Japanese Unexamined Patent Publication No. 58(1983)-16333. The position matching between the radiation image P1 and the radiation image P2 may be performed with a technique described in, for example, Japanese Unexamined Patent Publication No. 2001-325584, wherein a structural corresponding position relationship of the specific structure is calculated, and the positions of the radiation images are matched with each other in accordance with the structural corresponding position relationship having been calculated. In cases where the position matching between the radiation image P1 and the radiation image P2 is thus performed, an artifact occurring due to the shift is capable of being suppressed.

After the image recording operations have been performed with the radiation image recording apparatus 30, the first stimulable phosphor sheet 51 and the second stimulable phosphor sheet 52 are set one after the other at a predetermined position in a radiation image read-out apparatus 60. With the radiation image read-out apparatus 60, the radiation image P1 and the radiation image P2 are read out respectively from the first stimulable phosphor sheet 51 and the second stimulable phosphor sheet 52. In this manner, a radiation image signal (a digital image signal) S1 representing the radiation image P1 and a radiation image signal (a digital image signal) S2 representing the radiation image P2 are acquired.

Specifically, firstly, the first stimulable phosphor sheet 51, on which the radiation image P1 of the object 40 before being injected with the contrast medium has been stored, is set at the predetermined position in the radiation image read-out apparatus 60. The first stimulable phosphor sheet 51 is conveyed in a sub-scanning direction, which is indicated by the arrow Y, by sheet conveying means 61. The sheet conveying means 61 may be constituted of, for example, an endless belt, which is driven by driving means (not shown). Also, a laser beam L is produced by a laser beam source 62. The laser beam L acts as stimulating rays, which cause the stimulable phosphor sheet to emit light in proportion to the amount of energy stored on the stimulable phosphor sheet during the exposure of the stimulable phosphor sheet to the radiation. The laser beam L, which has been produced by the laser beam source 62, is reflected and deflected by a rotating polygon mirror 64, which is driven by a motor 63 and rotates quickly in the direction indicated by the arrow R. The laser beam L then passes through a converging lens 65, such as an fθ lens. Thereafter, the direction of the optical path of the laser beam L is changed by a mirror 66, and the laser beam L impinges upon the first stimulable phosphor sheet 51. In this manner, the laser beam L scans the first stimulable phosphor sheet 51 in a main scanning direction, which is indicated by the arrow X and is approximately normal to the sub-scanning direction indicated by the arrow Y. As a result, the portion of the first stimulable phosphor sheet 51, which portion is exposed to the laser beam L, emits light M1 in proportion to the amount of energy stored at the portion of the first stimulable phosphor sheet 51 during the exposure of the first stimulable phosphor sheet 51 to the radiation. The emitted light Ml is guided by a light guide member 67 and is photoelectrically detected by a photomultiplier 68.

In the manner described above, an analog signal A1 is generated by the photomultiplier 68. The analog signal A1 is logarithmically amplified by a logarithmic amplifier 69 and is then fed into an analog-to-digital converter 70. The analog signal A1 is sampled and digitized by the analog-to-digital converter 70. In this manner, the digital image signal S1, which represents the radiation image P1 of the object 40 before being injected with the contrast medium, is obtained. The image signal S1 is stored in an internal memory (not shown) of an image processing and displaying apparatus 80.

Thereafter, in the same manner as that described above, the digital image signal S2, which represents the radiation image P2 of the object 40 after being injected with the contrast medium, is obtained. The image signal S2 is stored in the internal memory (not shown) of the image processing and displaying apparatus 80.

The image processing and displaying apparatus 80 comprises a main body section 83, which is provided with image processing means 20 and subtraction processing means 10 and performs various kinds of image processing on the image signal. The image processing and displaying apparatus 80 also comprises a keyboard 81, from which various instructions, and the like, are inputted. The image processing and displaying apparatus 80 further comprises a CRT display device 82 for displaying auxiliary information for giving instructions and a visible image reproduced from the image signal.

In the image processing and displaying apparatus 80, the position matching between the radiation image P1, which is represented by the image signal S1, and the radiation image P2, which is represented by the image signal S2, is performed. Thereafter, the subtraction process is performed on image signal components of the image signal S1 and the image signal S2, which image signal components represent corresponding pixels in the radiation image P1 and the radiation image P2. In this manner, a subtraction image signal S is obtained.

The thus obtained subtraction image signal S is fed into the CRT display device 82 and is utilized for reproducing a subtraction image P, which is a visible image. The thus reproduced subtraction image P has good image quality and is capable of serving as an effective tool in, particularly, the efficient and accurate diagnosis of an illness. The subtraction image P is utilized in making a diagnosis.

FIG. 3 shows how the subtraction process is performed with the method of forming a subtraction image in accordance with the present invention in order to obtain an image of a desired specific structure (in this case, a blood vessel of the abdomen). In FIG. 3, P1 represents the image obtained from the first stimulable phosphor sheet 51, on which the radiation image of the object 40 before being injected with the contrast medium has been stored. Also, P2 represents the image obtained from the second stimulable phosphor sheet 52, on which the radiation image of the object 40 after being injected with the contrast medium has been stored. Further, P represents a contrasted blood vessel image. The contrasted blood vessel image is the subtraction image obtained from the subtraction process for subtracting the image signal S1, which represents the image P1, from the image signal S2, which represents the image P2. In cases where the object 40 has an arteriosclerosis focus, since the hydrophobic iodine compound is accumulated at the arteriosclerosis focus, a contrasted image, in which a pattern of the arteriosclerosis focus has been enhanced, is capable of being obtained.

In the embodiment described above, the plurality of the radiation image signals, which are to be subjected to the subtraction process, are obtained with the technique for scanning the stimulable phosphor sheets.

Alternatively, the plurality of the radiation image signals, which are to be subjected to the subtraction process, maybe obtained with one of other techniques, such as a technique utilizing a solid-state detector.

The liposome, which contains a hydrophobic iodine compound as the film forming constituent and is employed as the contrast medium to be injected into the fi object in the method of forming a subtraction image in accordance with the present invention, will hereinbelow be described in detail.

No limitation is imposed upon the kind of the hydrophobic iodine compound. The hydrophobic iodine compound should preferably be, for example, an iodobenzene derivative, should more preferably be a 1,3,5-triiodobenzene derivative, which has at least one substituent group having at least 18 carbon atoms. The substituent group having at least 18 carbon atoms should preferably be a hydrophobic group for stably locating the 1,3,5-triiodobenzene residue, which acts as an iodine contrasting site, at a lipid dual layer of the liposome. The substituent group having at least 18 carbon atoms should preferably be, for example, a hydrophobic group having at least 20 carbon atoms, in which the total sum of the number of oxygen atoms and the number of nitrogen atoms is at most ten. The hydrophobic substituent group should more preferably be a substituent group having a structure approximately identical with the structure of an organism membrane lipid constituent. Preferable examples of the hydrophobic iodine compounds satisfying the requirements described above include 1, 3, 5-triiodobenzene derivatives having a residue of a cholesterol derivative as the substituent group. The 1,3,5-triiodobenzene derivatives having a residue of a cholesterol derivative as the substituent group are described in, for example, J. Med. Chem. 25(12), 1500 (1982); Steroids 49(6), 531 (1987); Pharm. Res. 6(12), 1011 (1989); and PCT International Publication Nos. WO 95/19186 and WO 96/28414.

The cholesterol derivative should preferably be one of the cholesterol derivatives described in the publications enumerated above, and should more preferably be cholesterol. Specifically, cholesterol should preferably be coupled via its 3-position hydroxyl group with the hydrophobic iodine compound, e.g. 1,3,5-triiodobenzene. The hydroxyl group of cholesterol and the hydrophobic iodine compound, e.g. 1,3,5-triiodobenzene, may be linked with each other via means such as, an ester linkage, an ether linkage, a urethane linkage, or a carbonic acid ester linkage, and should preferably be linked with each other via the ester linkage. Cholesterol and the hydrophobic iodine compound, e.g. 1,3,5-triiodobenzene, may be linked directly with each other via the linkage described above or may be linked with each other via an appropriate connecting group. Examples of the appropriate connecting groups include straight-chain or branched alkylene groups having at most five carbon atoms.

Besides the aforesaid substituent group having at least 18 carbon atoms, the hydrophobic iodine compound, which should preferably be the 1,3,5-triiodobenzene compound, may also have one substituent group or at least two substituent groups. No limitation is imposed upon the kind of the substituent group and the position of substitution. However, for example, the substituent group, such as a substituted or unsubstituted amino group, a substituted or unsubstituted acylamino group, a hydroxyl group, or a carboxyl group, should preferably substitute on the benzene ring of the hydrophobic iodine compound. The substituent group should preferably be the substituted or unsubstituted amino group, or the substituted or unsubstituted acylamino group. In cases where the substituent group is the substituted amino group, the substituted amino group may be a monoalkylamino group, a dialkylamino group, or the like. In cases where the substituent group is the substituted acylamino group, the substituted acylamino group may be a trifluoroacetylamino group, a p-chlorobenzoylamino group, or the like.

As preferable examples of the hydrophobic iodine compounds, hydrophobic iodine compounds (0-1) to (0-9) are listed below. However, in the method of forming a subtraction image in accordance with the present invention, the liposome employed as the contrast medium is not limited to the liposomes containing the hydrophobic iodine compounds (0-1) to (0-9) listed below.

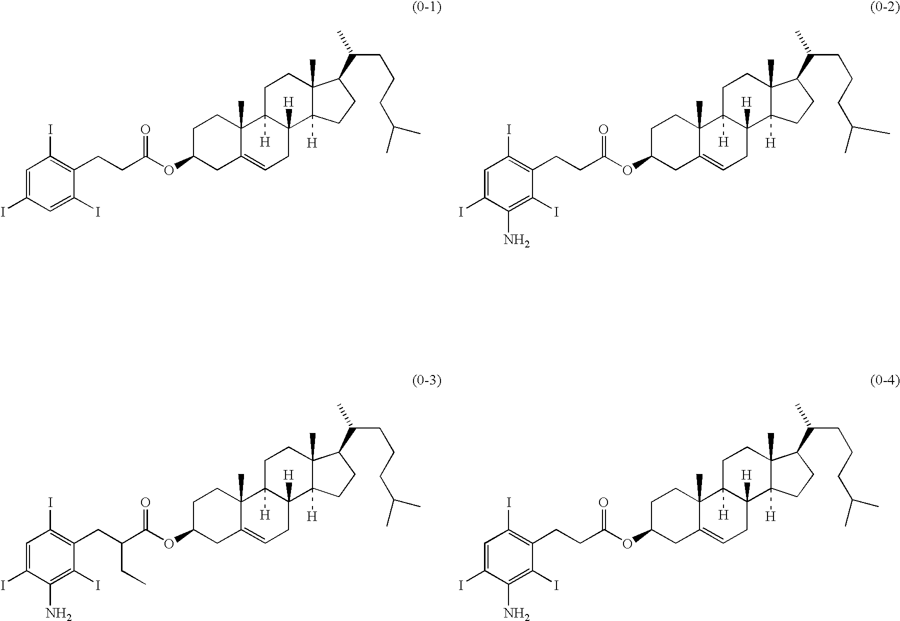

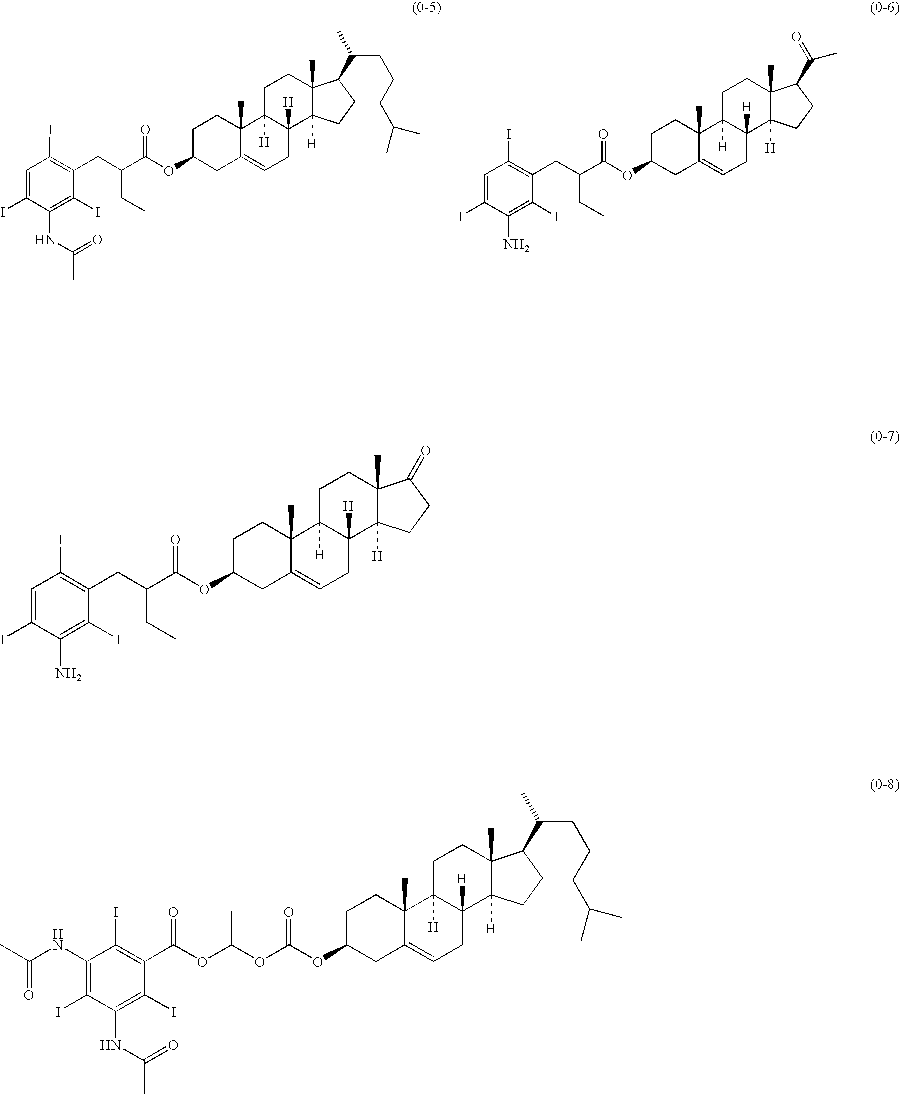

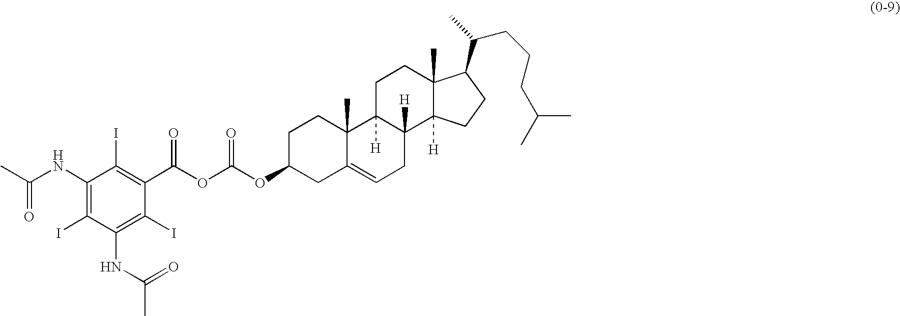

Also, as the hydrophobic iodine compound, an iodobenzene compound, which may be represented by Formula (I) shown below, may be employed.
A-L′-O-Ste (I)

In Formula (I) shown above, A represents:
A¹, which may be represented by Formula (II): 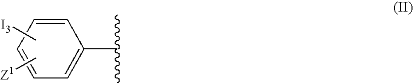
   wherein Z¹ represents a hydrogen atom or an amino group (provided that the amino group is an unsubstituted amino group);
A², which may be represented by Formula (III): 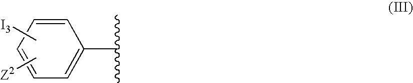
   wherein Z² represents an amino group (provided that the amino group is a mono-substituted or di-substituted amino group), an alkyl group, an alkenyl group, an alkynyl group, an aromatic group, a non-aromatic heterocyclic group, an alkoxy group, an aryloxy group, a hydroxyl group, a carboxyl group, a carbonyl group, a cyano group, a nitro group, a sulfo group, an amido group, an ester group, a carbamoyl group, a mercapto group, an alkylthio group, an acyl group, an alkoxycarbonyl group, or a halogen atom; or
A³, which may be represented by Formula (IV): 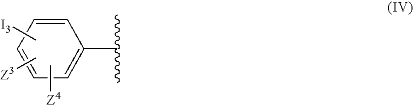
   wherein each of Z³ and Z⁴ independently represents an amino group, an alkyl group, an alkenyl group, an alkynyl group, an aromatic group, a non-aromatic heterocyclic group, an alkoxy group, an aryloxy group, a hydroxyl group, a carboxyl group, a carbonyl group, a cyano group, a nitro group, a sulfo group, an amido group, an ester group, a carbamoyl group, a mercapto group, an alkylthio group, an acyl group, an alkoxycarbonyl group, or a halogen atom.

Also, in Formula (I) shown above, L¹ represents:
L², wherein L² represents a connecting group, which may be represented by Formula (V):
   —X—Y— (V)
   wherein X represents —C(R¹)(R²)—, —CO—, —N(R¹)—, —O—, —S—, —SO—, or —SO₂—, in which each of R¹ and R² independently represents a hydrogen atom, a C₁₋₁₀ aliphatic group, or a C₆₋₂₀ aromatic group, and Y represents —C(R³)(R⁴)—, —CO—, —SO—, or —SO₂—, in which each of R³ and R⁴ independently represents a hydrogen atom, a C₁₋₁₀ aliphatic group, or a C₆₋₂₀ aromatic group;
L³, wherein L³ represents a bivalent connecting group, in which a main chain is constituted of three carbon atoms and which is constituted of a group selected from the group consisting of an alkyl group, an alkenyl group, an alkynyl group, and an alkylcarbonyl group;
L⁴, wherein L⁴ represents a bivalent connecting group, in which a main chain is constituted of three atoms, and at least one of the three atoms is a hetero-atom, except for —CO—O—CO—, and wherein L⁴ should preferably represent a bivalent connecting group, in which the main chain is constituted of three atoms and which is constituted of a group selected from the group consisting of an ester group, a carbonic acid ester group, an amido group, a urethane group, a urea group, an ether group, an oxyalkylcarbonyl group, an amino group, and an aminoalkylcarbonyl group; or
L⁵, which may be represented by Formula (VI):
   -L^{a}-L^{b}-L^{c}- (VI)
   wherein each of L^{a} and L^{c} independently represents a single bond or a bivalent connecting group, in which bivalent connecting group a main chain is constituted of one to nine atoms and may optionally contain at least one hetero-atom and/or at least one unsaturated bond, each of L [symbol] and L [symbol] should preferably independently represent a single bond or a bivalent connecting group, in which bivalent connecting group a main chain is constituted of one to nine atoms and which bivalent connecting group is constituted of a group selected from the group consisting of an alkyl group, an alkenyl group, an alkynyl group, an alkylcarbonyl group, an ester group, a carbonic acid ester group, an amido group, a urethane group, a urea group, an ether group, an amino group, and a combination of two or more of the above-enumerated groups, and L^{b} represents a —CH₂—CH₂— group, a —CH═CH— group, a —C≡C— group, a —CO—CH₂— group, or a —CH₂—CO— group, each of which groups may optionally have a substituent group, provided that the number of the main chain of -L^{a}-L^{b}-L^{c}- is four to 11.

Further, in Formula (I) shown above, Ste represents:
Ste¹, wherein Ste¹ represents a steroid residue selected from the group consisting of cholesterol, dehydroepiandrosterone, and pregnenolone; or
Ste², wherein Ste² represents a steroid residue selected from the group consisting of cholestanol, cholic acid, dehydrocholic acid, androsterone, digitoxigenin, digoxigenin, lithocholic acid, stigmastanol, tetrahydrocortisone, bufalin, 5α-androstane-3β,17β-diol, 5-androstene-3β,17β-diol, 5-cholesten-3β,20α-diol, stigmasterol, β-sitosterol, 5-cholesten-3β-ol-7-one, campesterol, 22-hydroxycholesterol, 17β-acetoxypregnenolone, diosgenine, methylandrostenediol, 5-androstene-3β-ol-17β-carboxylic acid, 17α-hydroxypregnenolone, 21-acetoxypregnenolone, 16β-methyl-16α,17α-epoxypregnenolone, fucosterol, solasodine, 5-pregnene-6-methyl-3β,17-diol-20-one, 6-methylpregnenolone, 21-hydroxypregnenolone, 5-pregnene-3β,20α-diol, 19-iodocholesterol, 16α-methylpregnenolone, 5-androstene-3β,17β-diol-17-benzoate, 5-androstene-3β,16α-diol-17-one, 3β,11β,17α,21-tetrahydropregn-5-en-20-one, 5-pregnene-3β,16α-diol-20-one, a 5-cholestenic acid-3β-ol methyl ester, desmosterol, 5-cholesten-3β-ol-22-one, pregn-5-en-3β,17α,20α-triol, 19-hydroxycholesterol, solanidine, 25-hydroxycholesterol, 7β-hydroxycholesterol, 19-hydroxypregnenolone, 17α-hydroxy-16β-methylpregnenolone, 16,17-epoxy-21-acetoxypregnenolone, 5-pregnene-6,16α-dimethyl-3β-ol-20-one, 5-cholestenic acid-3β-ol, androst-5-ene-3β,16β,17β-triol, 5-cholesten-3β,22-diol, pregn-5-ene-3β,17α,20β-triol, a 21-hydroxypregnenolone-21-sulfate potassium salt, 5-pregnen-3β-ol-20-one-16α-carbonitrile, and 16α,17α-epoxypregnenolone.

However, in Formula (I) shown above, the cases are excluded wherein A represents A¹, L¹ represents L³, and at the same time Ste represents Ste¹.

The term “substituted or unsubstituted” and the term “may optionally have a substituent group” as used herein for a certain functional group mean that the functional group may optionally have one substituent group or two or more substituent groups. Unless otherwise specified, no limitation is imposed upon the number of the substituent groups, the position of substitution, and the kind of the substituent group. In cases where a certain functional group has at least two substituent groups, the at least two substituent groups may be identical with each other or different from each other. In this specification, in cases where a certain functional group has a substituent group, examples of the substituent groups include a halogen atom (the term “halogen atom” as used herein means any of fluorine, chlorine, bromine, and iodine), an alkyl group (the term “alkyl group” as used herein means any of a straight-chain alkyl group, a branched alkyl group, a cyclic alkyl group, and a combination of two or more of the above enumerated alkyl groups, the cyclic alkyl group including a polycyclic alkyl group, such as a bicycloalkyl group, and an alkyl moiety of each of other substituent groups, which contain the alkyl moiety, has the same meaning as the alkyl group), an alkenyl group (including a cycloalkenyl group and a bicycloalkenyl group), an alkynyl group, an aryl group, a heterocyclic group, a cyano group, a hydroxyl group, a nitro group, a carboxyl group, an alkoxy group, an aryloxy group, a silyloxy group, a heterocyclic oxy group, an acyloxy group, a carbamoyloxy group, an alkoxycarbonyloxy group, an aryloxycarbonyloxy group, an amino group (including an anilino group), an acylamino group, an aminocarbonylamino group, an alkoxycarbonylamino group, an aryloxycarbonylamino group, a sulfamoylamino group, an alkylsulfonylamino group, an arylsulfonylamino group, a mercapto group, an alkylthio group, an arylthio group, a heterocyclic thio group, a sulfamoyl group, a sulfo group, an alkylsulfinyl group, an arylsulfinyl group, an alkylsulfonyl group, an arylsulfonyl group, an acyl group, an aryloxycarbonyl group, an alkoxycarbonyl group, a carbamoyl group, an arylazo group, a heterocyclic azo group, an imido group, a phosphino group, a phosphinyl group, a phosphinyloxy group, a phosphinylamino group, and a silyl group.

The term “mono-substituted or di-substituted amino group” as used herein means that the amino group has one or two substituent groups, which are among the above-enumerated substituent groups, preferably alkyl groups. In cases where the amino group has two substituent groups, the two substituent groups, may be identical with each other or different from each other. Also, the term “aromatic group” as used herein has a meaning including an aromatic hydrocarbon group (i.e., an aryl group) and an aromatic heterocyclic group. An aryl moiety in a substituent group, which contains the aryl moiety, may be a single-ring or condensed ring aryl group having six to 14 members, such as a phenyl group or a naphthyl group.

In the triiodophenyl group, which is represented by each of A¹, A², and A³, the positions of substitution of the three iodine atoms maybe the 2-, 4-, and 6-positions. Alternatively, the positions of substitution of the three iodine atoms maybe the 2-, 3-, and 4-positions. As another alternative, the positions of substitution of the three iodine atoms may be the 2-, 3-, and 5-positions. However, the positions of substitution of the three iodine atoms should preferably be the 2-, 4-, and 6-positions, or the 2-, 3-, and 5-positions. The positions of substitution of the three iodine atoms should more preferably be the 2-, 4-, and 6-positions.

Also, in cases where Z², Z³, or Z⁴ represents an alkyl group, the alkyl group should preferably have one to 20 carbon atoms, and should more preferably have one to ten carbon atoms. The alkyl group may optionally have a substituent group. In cases where Z², Z³, or Z⁴ represents an alkenyl group, the alkenyl group should preferably have one to 20 carbon atoms, and should more preferably have one to ten carbon atoms. The alkenyl group may optionally have a substituent group. In cases where Z², Z³, or Z⁴ represents an alkynyl group, the alkynyl group should preferably have one to 20 carbon atoms, and should more preferably have one to ten carbon atoms. The alkynyl group may optionally have a substituent group.

In cases where Z2, Z³, or Z⁴ represents a substituted amino group, the substituted amino group should preferably have one to 20 carbon atoms, and should more preferably have one to 12 carbon atoms. The substituted amino group should preferably be a monoalkylamino group or a dialkylamino group. In cases where the substituted amino group is a dialkylamino group, the two alkyl substituent groups of the dialkylamino group may be identical with each other or different from each other. The alkyl substituent group on the amino group may further have a substituent group.

In cases where Z², Z³, or Z⁴ represents an aromatic group, the ring which constitutes the aromatic group should preferably be a benzene ring, a pyridine ring, a thiophene ring, a furan ring, a pyrrole ring, a pyrimidine ring, a triazine ring, a tetrazole ring, a thiadiazole ring, an oxadiazole ring, an oxazole ring, a thiazole ring, an isoxazole ring, or an isothiazole ring. An aromatic group, to which a condensed ring is bonded, is also preferable. The aromatic group should more preferably be an aromatic group constituted of the benzene ring, the thiophene ring, the furan ring, or the pyrrole ring. The aromatic group should most preferably be the aromatic group, which contains the benzene ring, or a phenyl group. The aromatic rings enumerated above may further have a substituent group.

In cases where Z², Z³, or Z⁴ represents a non-aromatic heterocyclic group, the non-aromatic heterocyclic group should preferably have one to 20 carbon atoms, and should more preferably have one to 12 carbon atoms. Examples of heterocyclic rings constituting the non-aromatic heterocyclic groups include partially or completely saturated rings of an oxazole ring, a thiazole ring, a pyridine ring, a pyrimidine ring, a triazine ring, a pyrrole ring, an imidazole ring, a pyrazole ring, a 1,2,4-triazole ring, a tetrazole ring, a 1,3,4-thiadiazole ring, a 1,2,4-thiadiazole ring, a thiophene ring, and a furan ring. Examples of the heterocyclic rings constituting the non-aromatic heterocyclic groups also include condensed rings of the above-enumerated rings with different rings (e.g., aromatic rings, such as benzene ring and pyridine ring, and non-aromatic rings). The non-aromatic heterocyclic group may further have a substituent group.

In cases where Z², Z³, or Z⁴ represents an alkoxy group, the alkoxy group should preferably have one to 20 carbon atoms, and should more preferably have one to 12 carbon atoms. The alkoxy group may further have a substituent group. In cases where Z², Z³, or Z⁴ represents an aryloxy group, the aryloxy group should preferably have six to 20 carbon atoms, and should more preferably have six to 12 carbon atoms. The aryloxy group may further have a substituent group. In cases where Z², Z³, or Z⁴ represents a carbonyl group, the carbonyl group should preferably have one to 20 carbon atoms, and should more preferably have one to ten carbon atoms. The carbonyl group may further have a substituent group.

In cases where Z², Z³, or Z⁴ represents an amido group, the amido group contains in its scope a carboamido group, a sulfonamido group, an alkoxycarbonylamino group, an aryloxycarbonylamino group, and a ureido group. The amido group should preferably have one to 20 carbon atoms, and should more preferably have one to 12 carbon atoms. Examples of the amido groups include an acetylamino group, a benzoylamino group, a methanesulfonylamino group, a 3,3-dimethylureido group, a t-butoxycarbonylamino group, a benzyloxycarbonylamino group, a benzenesulfonylamino group, and a trifluoroacetylamino group. The amido group may have a substituent group.

In cases where Z², Z³, or Z⁴ represents an ester group, the ester group includes in its scope a carboxylic acid ester group, a sulfonic acid ester group, an acyloxy group, an alkoxycarbonyl group, an aryloxycarbonyl group, an alkoxycarbonyloxy group, an aryloxycarbonyloxy group, and a carbonic acid ester group. The ester group should preferably have one to 20 carbon atoms, and should more preferably have one to 12 carbon atoms. Examples of the ester groups include an acetyloxy group, a benzoyloxy group, a methanesulfonyloxy group, a methoxycarbonyl group, a benzyloxycarbonyl group, a methoxysulfonyl group, a t-butoxycarbonyloxy group, a benzyloxycarbonyloxy group, a benzenesulfonyloxy group, and a trifluoroacetyloxy group. In cases where Z², Z³, or Z⁴ represents a halogen atom, the halogen atom may be any of fluorine, chlorine, bromine, and iodine, and should preferably be fluorine or chlorine.

Each of Z², Z³, and Z⁴ should preferably be an alkyl group, a cyano group, a hydroxyl group, an alkoxy group, an amino group, a mercapto group, an alkylthio group, an acyl group, an alkoxycarbonyl group, or a carbamoyl group. Each of Z², Z³, and Z⁴ should more preferably be a hydroxyl group, an alkoxy group, or an amino group. Also, the triiodophenyl group represented by A¹, wherein Z¹ represents a hydrogen atom, is also preferable.

The term “steroid residue” as used herein means the residue of a steroid compound (i.e., a compound having a cyclopentanohydrophenanthrene skeleton). The steroid residue may be a monovalent residue. Alternatively, the steroid residue may be a bivalent or polyvalent residue. In this specification, the steroid residue may be a substituted steroid residue or an unsubstituted steroid residue. Also, the steroid residue may have an arbitrary number of double bond. The steroid residue ordinarily have at least one asymmetric carbon atom. The configurations of the asymmetric carbon atoms may independently be an R-configuration or an S-configuration. Alternatively, the configurations of the asymmetric carbon atoms may be a mixture of the R-configuration and the S-configuration.

Unless otherwise specified, examples of the steroid compounds constituting the steroid residues described above include cholesterol, cholestanol, cholic acid, dehydrocholic acid, androsterone, digitoxigenin, digoxigenin, lithocholic acid, stigmastanol, tetrahydrocortisone, bufalin, 5α-androstane-3β,17β-diol, dehydroepiandrosterone, 5-androstene-3β,17β-diol, pregnenolone, 5-cholesten-3β,20α-diol, stigmasterol, β-sitosterol, 5-cholesten-3β-ol-7-one, campesterol, 22-hydroxycholesterol, 17α-acetoxypregnenolone, diosgenine, methylandrostenediol, 5-androstene-3β-ol-17β-carboxylic acid, 17α-hydroxypregnenolone, 21-acetoxypregnenolone, 16β-methyl-16α,17α-epoxypregnenolone, fucosterol, solasodine, 5-pregnene-6-methyl-3β,17-diol-20-one, 6-methylpregnenolone, 21-hydroxypregnenolone, 5-pregnene-3β,20α-diol, 19-iodocholesterol, 16α-methylpregnenolone, 5-androstene-3β,17β-diol-17-benzoate, 5-androstene-3β,16α-diol-17-one, 3β,11β,17α,21-tetrahydropregn-5-en-20-one, 5-pregnene-3β,16α-diol-20-one, a 5-cholestenic acid-3β-ol methyl ester, desmosterol, 5-cholesten-3β-ol-22-one, pregn-5-en-3β,17α,20α-triol, 19-hydroxycholesterol, solanidine, 25-hydroxycholesterol, 7β-hydroxycholesterol, 19-hydroxypregnenolone, 17α-hydroxy-16β-methylpregnenolone, 16,17-epoxy-21-acetoxypregnenolone, 5-pregnene-6,16α-dimethyl-3β-ol-20-one, 5-cholestenic acid-3β-ol, androst-5-ene-3β,16β,17β-triol, 5-cholesten-3β,22-diol, pregn-5-ene-3β,17α,20β-triol, a 21-hydroxypregnenolone-21-sulfate potassium salt, 5-pregnen-3β-ol-20-one-16α-carbonitrile, and 16α,17α-epoxypregnenolone. However, the steroid compound constituting the steroid residue is not limited to the steroid compounds enumerated above. The steroid residue should preferably be a steroid residue, which contains at least one double bond in the ring structure, or a cholestanol group. The steroid residue should more preferably be a cholesterol group.

No limitation is imposed upon the kind of the substituent group, by which the steroid residue may be substituted. Examples of the substituent groups, by which the steroid residue may be substituted, include an aliphatic group having one to 15 carbon atoms (such as an alkyl group, an alkynyl group, or an alkenyl group), an aryl group, a heterocyclic group, an amino group, an amido group, a carbamoyl group, a cyano group, a hydroxyl group, an alkoxy group, an alkoxycarbonyl group, a carbonyl group, and a carboxyl group. However, the substituent group, by which the steroid residue may be substituted, is not limited to those enumerated above. Also, the substituent groups enumerated above may further have a substituent group.

In the connecting group represented by L², X should preferably represent —C(R¹)(R²)—, —CO—, —N(R¹)—, —O—, or —S—, —SO—, and should more preferably represent —C(R¹)(R²)—, —CO—, or —O—. Also, in the connecting group represented by L², Y should preferably represent —C(R³)(R⁴)— or —CO—, and should more preferably represent —CO—. The term “aliphatic group” or the term “substituent group containing an aliphatic group” as used herein means a saturated or unsaturated hydrocarbon chain. The hydrocarbon chain moiety may be a straight chain, a branched chain, a cyclic chain, or a combination of two or more of these chains. Examples of the C₁₋₁₀ aliphatic groups, which may be represented by R¹, R², R³, or R⁴ described above, include an alkyl group (e.g., methyl, ethyl, n-propyl, isopropyl, t-butyl, or n-octyl), a cycloalkyl group (e.g., cyclohexyl, cyclopentyl, cyclobutyl, or cyclopropyl), a bicycloalkyl group, an alkenyl group (e.g., vinyl, allyl, or pulenyl), a cycloalkenyl group (e.g., 2-cyclopenten-1-yl or 2-cyclohexen-1-yl), a bicycloalkenyl group, and an alkynyl group (e.g., ethynyl or propargyl). Examples of the C₆₋₂₀ aromatic groups, which may be represented by R¹, R², R³, or R⁴ described above, include an aryl group (e.g., phenyl or naphthyl) and a heterocyclic group (e.g., 2-furyl, 2-thienyl, 2-pyrimidinyl, or 2-benzothiazolyl). R¹, R², R³, or R⁴ described above should preferably be a hydrogen atom or a C₁₋₆ alkyl group, and should more preferably be a hydrogen atom or a C₁₋₃ alkyl group.

In the connecting group represented by L [symbol] , the alkyl group, the alkenyl group, the alkynyl group, or the alkylcarbonyl group, which constitutes the main chain, may optionally have a substituent group. The term “main chain” as used herein for the connecting group means the atom group connecting the group, which is represented by A-, and the oxygen atom of the group, which is represented by —O-Ste, with a minimum number of atoms.

L⁴ represents the bivalent connecting group, in which the main chain is constituted of three atoms, and at least one of the three atoms is a hetero-atom. (The term “hetero-atom” as used herein means the atom other than the carbon atom.) No limitation is imposed upon the kind of the hetero-atom, which is contained in the main chain of the connecting group. Examples of the hetero-atoms include a nitrogen atom, an oxygen atom, and a sulfur atom. For example, the main chain of the connecting group should preferably contain a constituent unit, such as —N(R¹¹)—, —O—, or —S— (wherein R¹¹ represents a hydrogen atom or a substituent group, should preferably represent an alkyl group, or the like, should more preferably represent an alkyl group having one to six carbon atoms, and should most preferably represent an alkyl group having one to three carbon atoms). In cases where the main chain of the connecting group contains two consecutive carbon atoms, an unsaturated bond may be present in the carbon atom ring. The bivalent connecting group represented by L⁴ excludes the cases wherein the connecting group is —CO—O—CO—.

The carbon atom and/or the hetero-atom, which is contained in the main chain of the bivalent connecting group represented by L⁴, may optionally have a substituent group. In cases where the carbon atom, which is contained in the main chain of the bivalent connecting group represented by L⁴, has a substituent group, the substituent group may be, for example, an alkyl group, an oxo group, or the like, and should preferably be the oxo group. By way of example, the main chain of the bivalent connecting group represented by L⁴ should preferably be constituted of a group selected from the group consisting of an ester group, a carbonic acid ester group, an amido group, a urethane group, a urea group, an ether group, an oxyalkylcarbonyl group, an amino group, and an aminoalkylcarbonyl group. Specifically, examples of L⁴ include —N(R¹¹)—CH₂—CO—, —O—CO—CH₂—, —O—CH₂—CO—, CH₂—O—CO—, —CO—NH—CO—, and —CO—O—CH₂. (In the connecting group described above and in the other connecting groups described in this specification, A is bonded to the left side of the connecting group.)

In -L^{a}-L^{b}-L^{c}- represented by L⁵, each of L^{a} and L^{c} independently represents a single bond or a bivalent connecting group, in which bivalent connecting group a main chain is constituted of one to nine atoms and may optionally contain at least one hetero-atom and/or at least one unsaturated bond. In cases where each of L^{a} and L^{c} represents a bivalent connecting group, and the main chain of the connecting group contains a hetero-atom, the main chain of the connecting group should preferably contain a constituent unit represented by, for example, —N(R¹¹)—, —O—, or —S— (wherein R¹¹ represents a hydrogen atom or a substituent group, should preferably represent an alkyl group, or the like, should more preferably represent an alkyl group having one to six carbon atoms, and should most preferably represent an alkyl group having one to three carbon atoms). The main chain of each of L^{a} and L^{c} may be constituted of only the at least one hetero-atom. In cases where the main chain of each of L^{a} and L^{c} contains a carbon atom, the carbon atom may optionally have a substituent group, such as an alkyl group or an oxo group. In cases where each of L^{a} and L^{c} represents a bivalent connecting group, the bivalent connecting group should preferably be constituted of a group selected from the group consisting of an alkyl group, an alkenyl group, an alkynyl group, an alkylcarbonyl group, an ester group, a carbonic acid ester group, an amido group, a urethane group, a urea group, an ether group, an amino group, and a combination of two or more of the above-enumerated groups.

The constituent unit of the main chain of the bivalent connecting group, which may be represented by L^{a}, should preferably be —C(R¹²)(R¹³)—, —N(R¹⁴)—, —CO—, —O—, or —S— (wherein each of R¹², R¹³, and R¹⁴ independently represents a hydrogen atom or a substituent group, should preferably represent an alkyl group, or the like, should more preferably represent an alkyl group having one to six carbon atoms, and should most preferably represent an alkyl group having one to three carbon atoms). The constituent unit of the main chain of the bivalent connecting group, which may be represented by L^{a}, should more preferably be —O—. L^{a} should particularly preferably be such that the main chain of L^{a} contains the ether group —O—, and such that the ether group —O— is directly bonded to A.

The constituent unit of the main chain of the bivalent connecting group, which may be represented by L^{c}, should preferably be —C(R¹²)(R¹³)—, —N(R¹⁴)—, —CO—, —O—, —S—, —SO—, or —SO₂— (wherein each of R¹², R¹³, and R¹⁴ independently represents a hydrogen atom or a substituent group, should preferably represent an alkyl group, or the like, should more preferably represent an alkyl group having one to six carbon atoms, and should most preferably represent an alkyl group having one to three carbon atoms). The constituent unit of the main chain of the bivalent connecting group, which may be represented by L^{c}, should more preferably be —C(R¹²)(R¹³)—, —N(R¹⁴)—, —CO—, —O—, or —S—. The constituent unit of the main chain of the bivalent connecting group, which may be represented by L^{c}, should more preferably be —C(R¹²)(R¹³)—, —N(R¹⁴)—, —CO—, or —O—. L^{c} should particularly preferably be such that the main chain of L^{c} contains the carbonyl group —CO—, and such that the carbonyl group —CO—is directly bonded to —O-Ste. It is also preferable that L^{c} represents a single bond.

It is particularly preferable that the main chain of L^{a} contains the ether group —O—, and L^{c} is —CO—. In such cases, the ether group —O— contained in L^{a} should preferably be directly bonded to A. Also, the main chain of L^{a} and/or the main chain of L^{c} should preferably contain at least one partial structure, which is represented by —CO—N(R¹⁴)— or —N(R¹⁴)—CO—. Further, the total sum of the number of the atoms, which constitute the main chain of L^{a}, and the number of the atoms, which constitute the main chain of L^{c}, should preferably fall within the range of two to seven, and should more preferably fall within the range of two to five.

The —CH₂—CH₂— group, the —CH═CH— group, the —C≡C— group, the —CO—CH₂— group, or the —CH₂—CO— group, which is represented by L^{b}, may optionally have a substituent group. L^{b} should preferably represent the —CH₂—CH²— group, the —CH═CH— group, or the —CH₂—CO—group.

It is also preferable that the main chain of -L^{a}-L^{b}-L^{c}- represented by L⁵ is constituted of only the carbon atoms.

As preferable examples of the iodobenzene compound described above, compounds (I-1) to (VII-21) are shown below. However, the iodobenzene compound described above is not limited to those shown below.

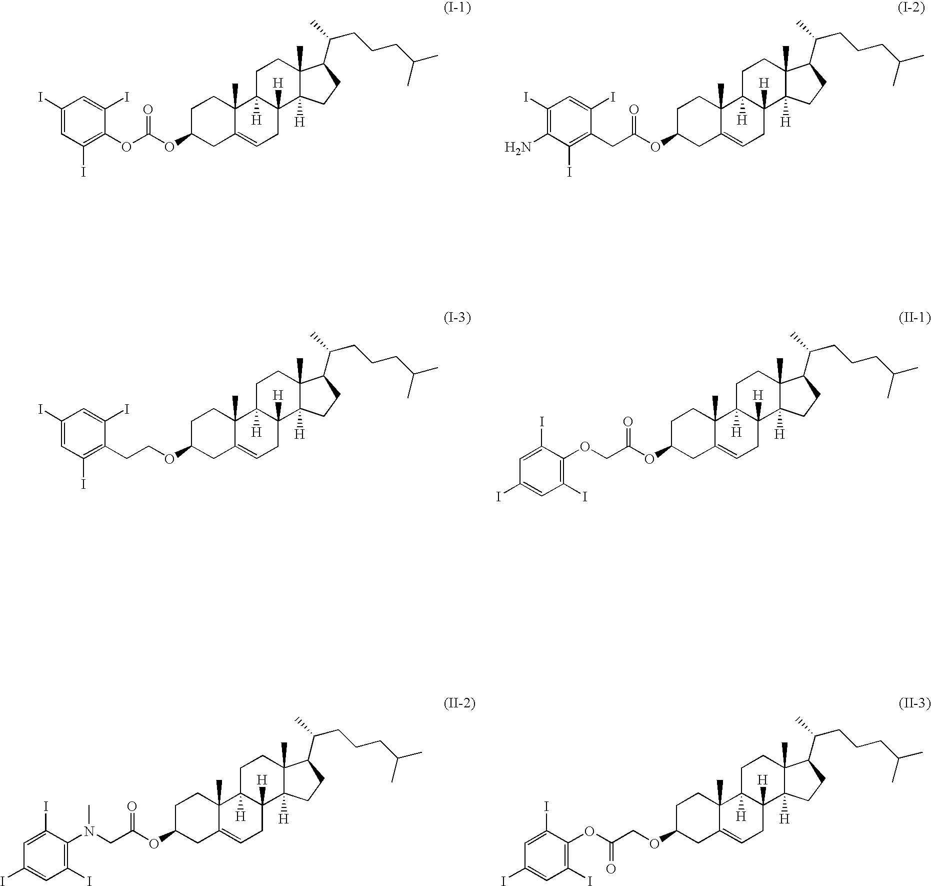

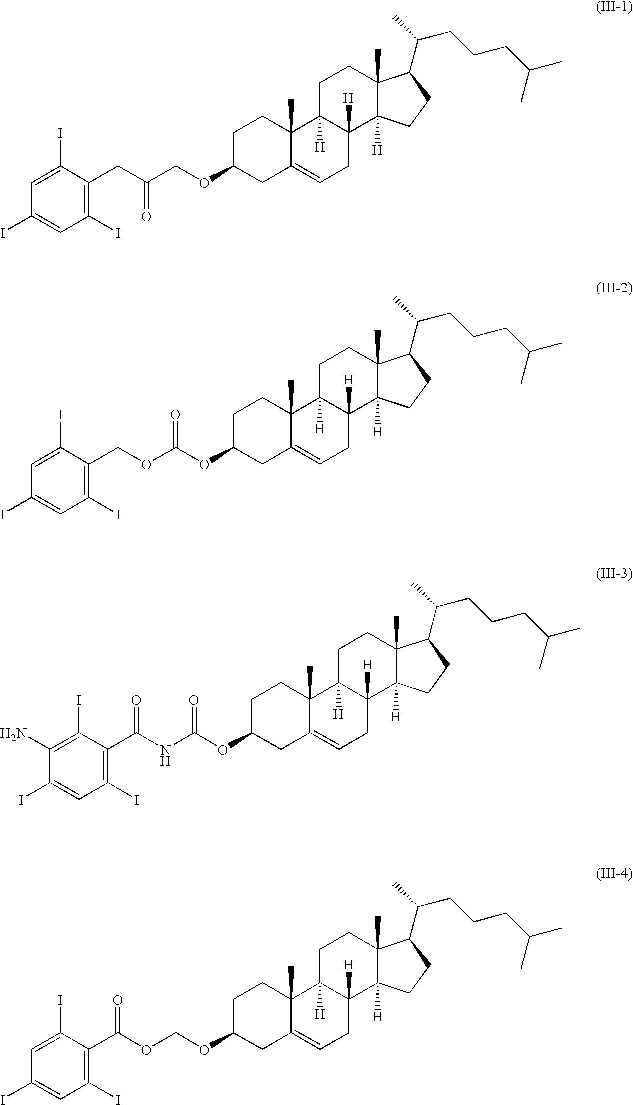

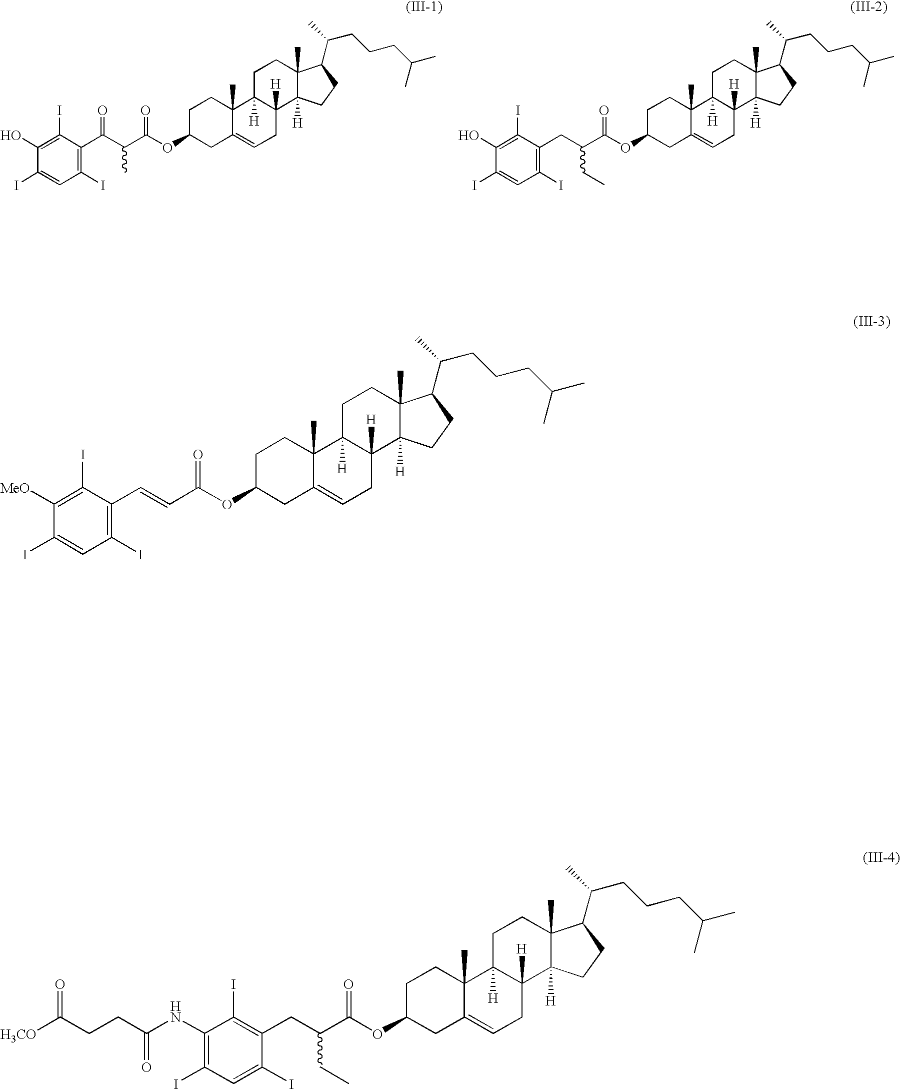

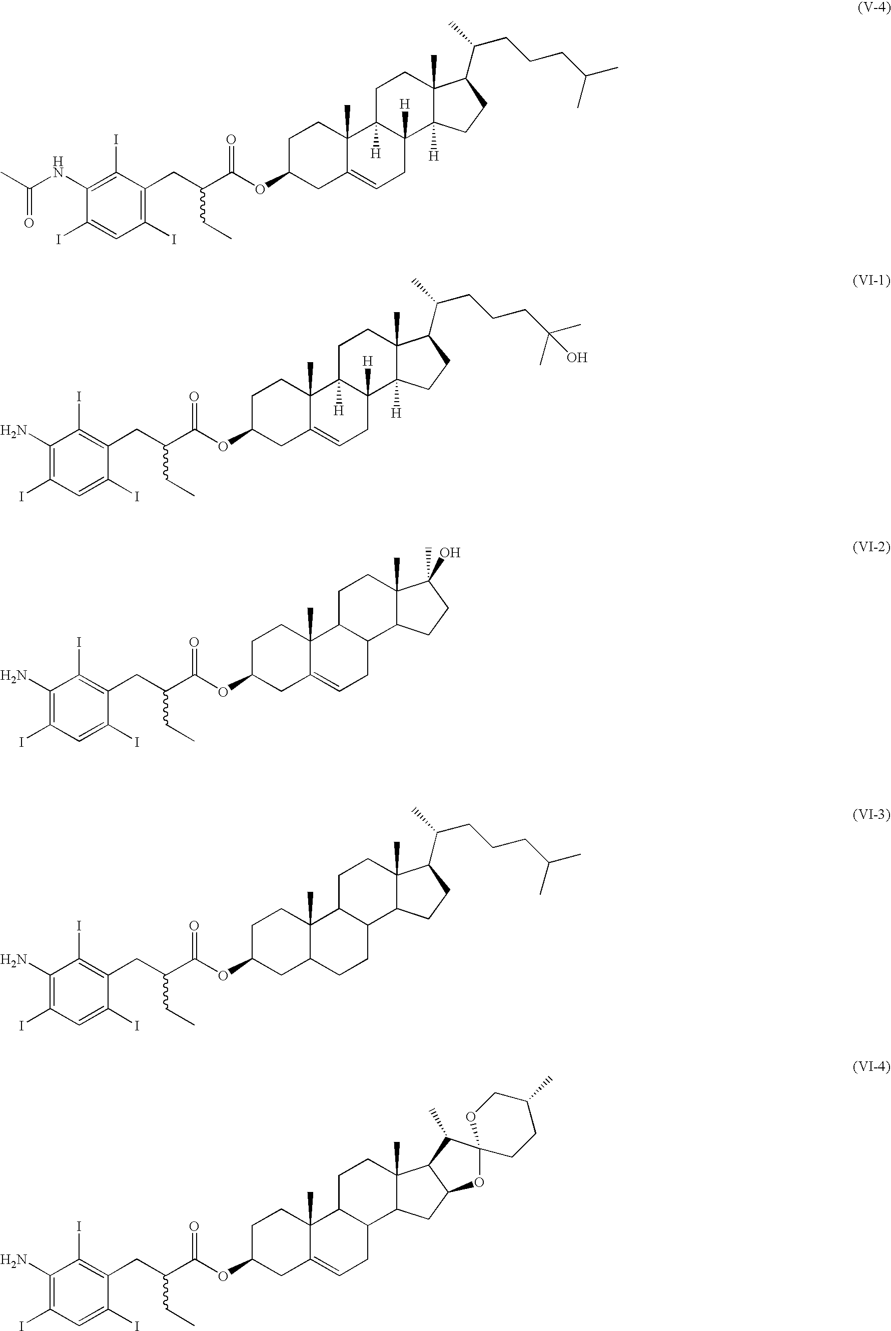

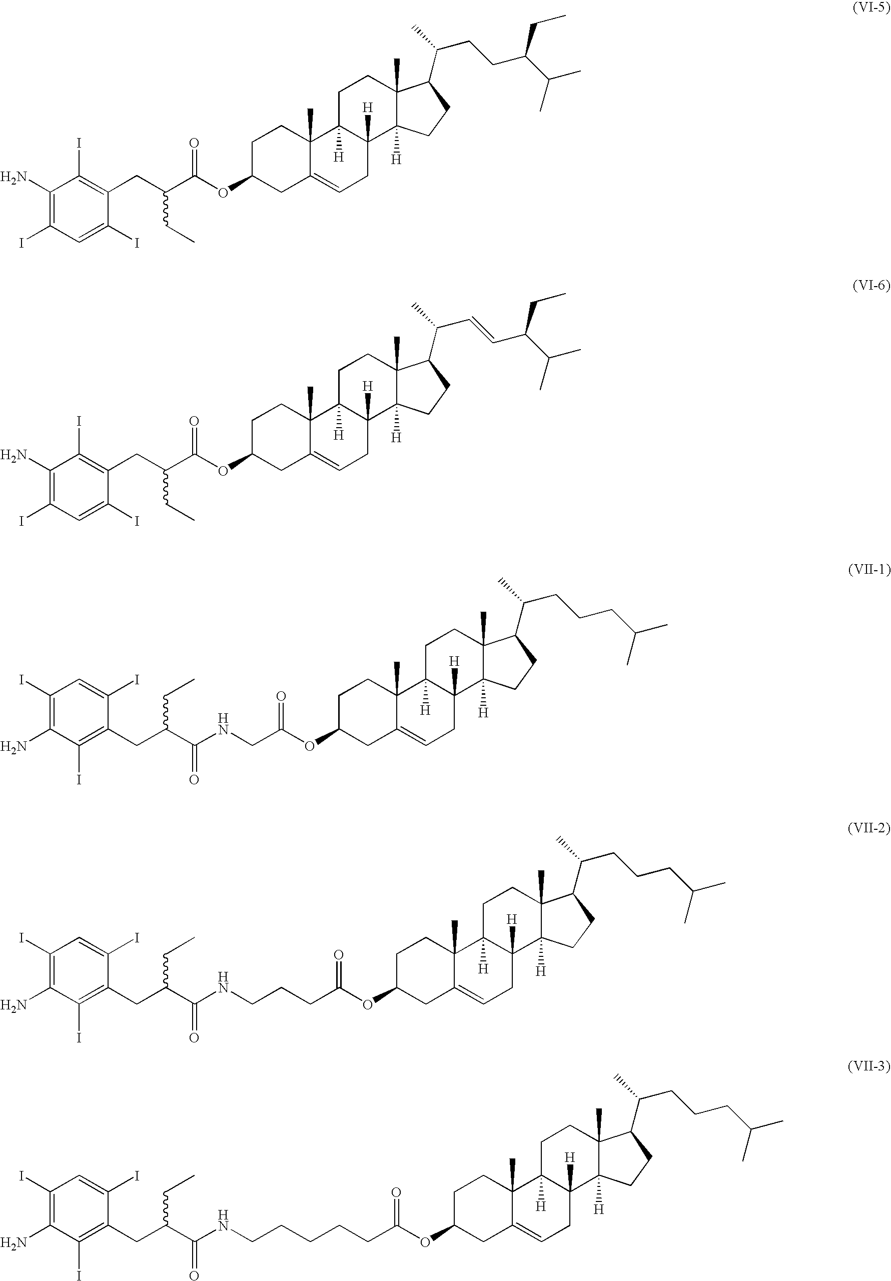

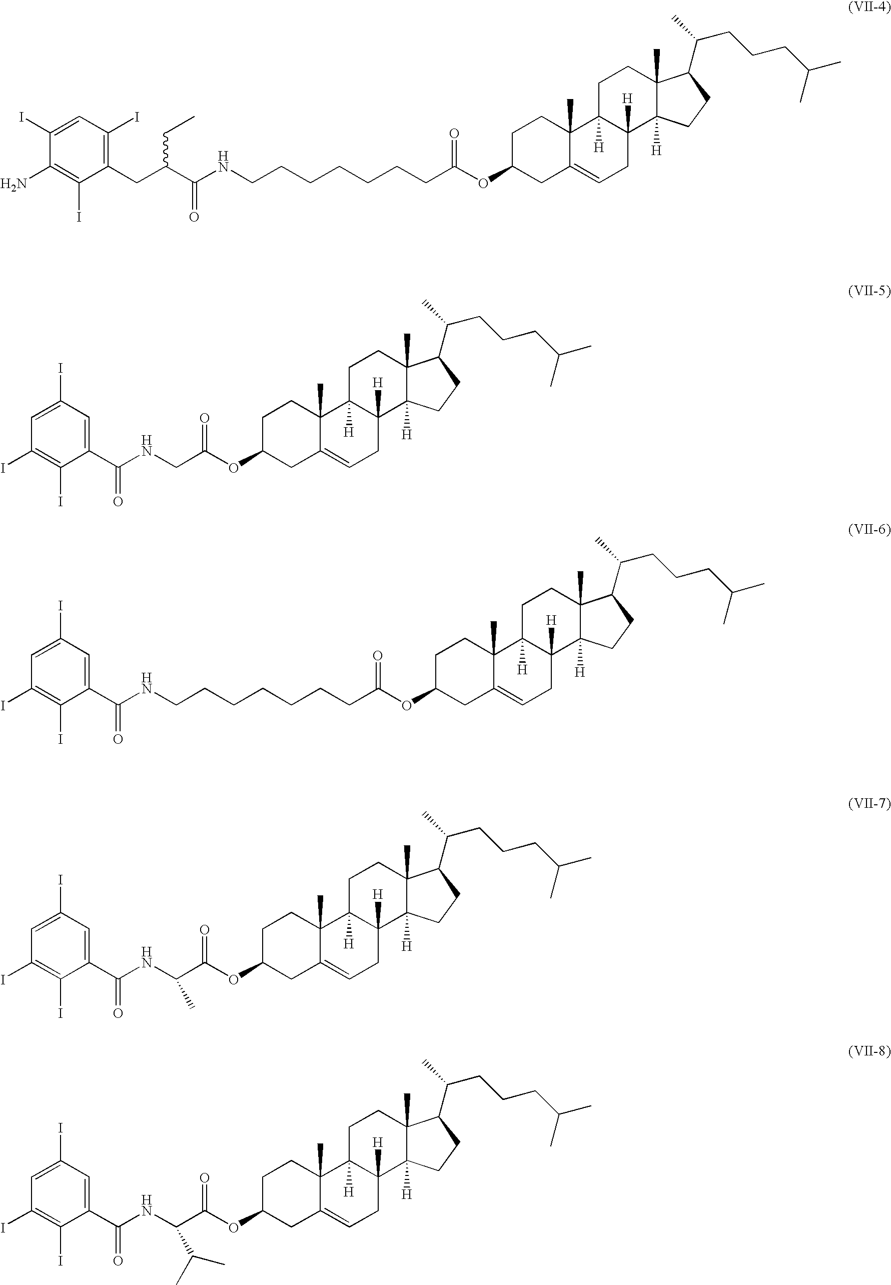

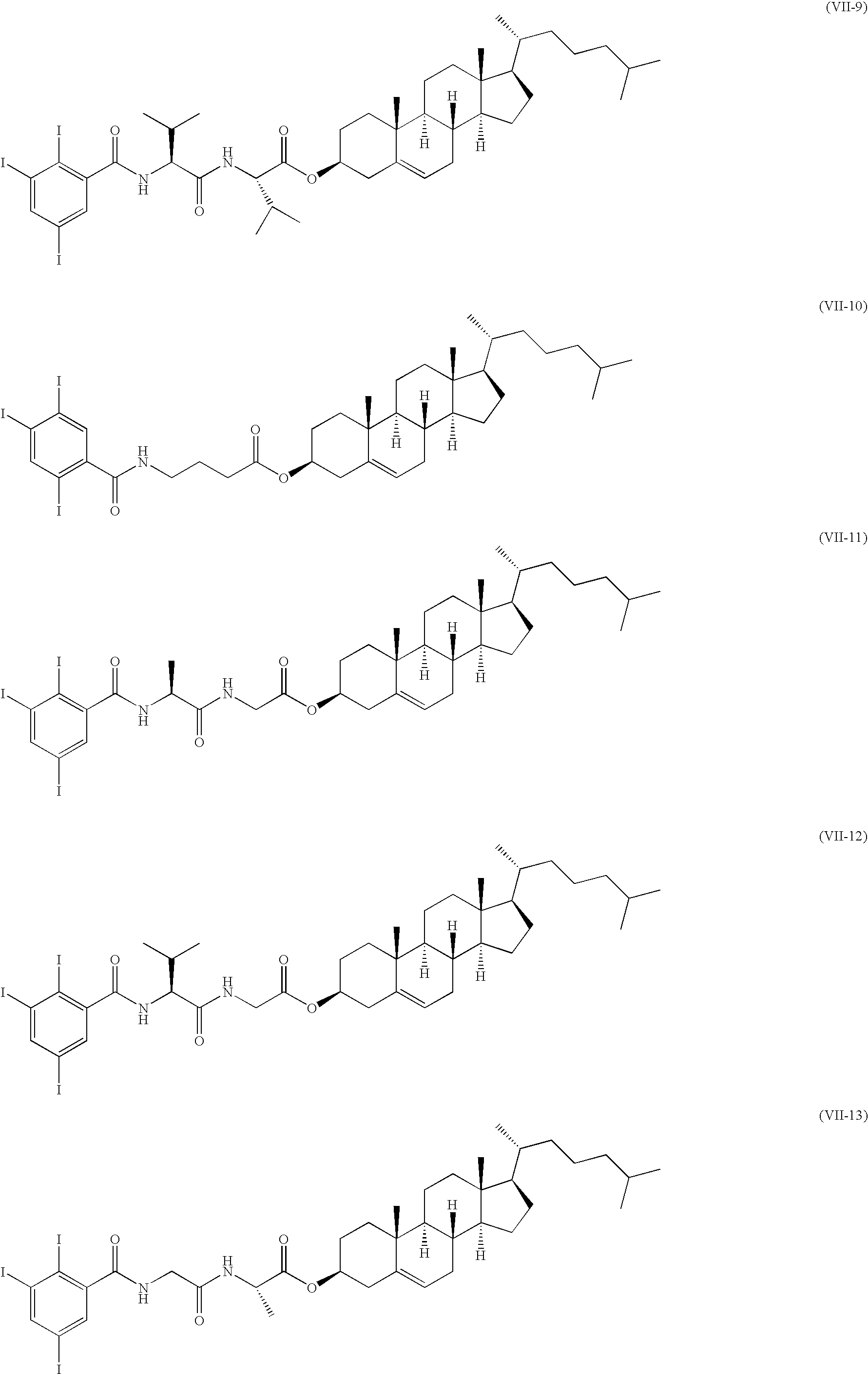

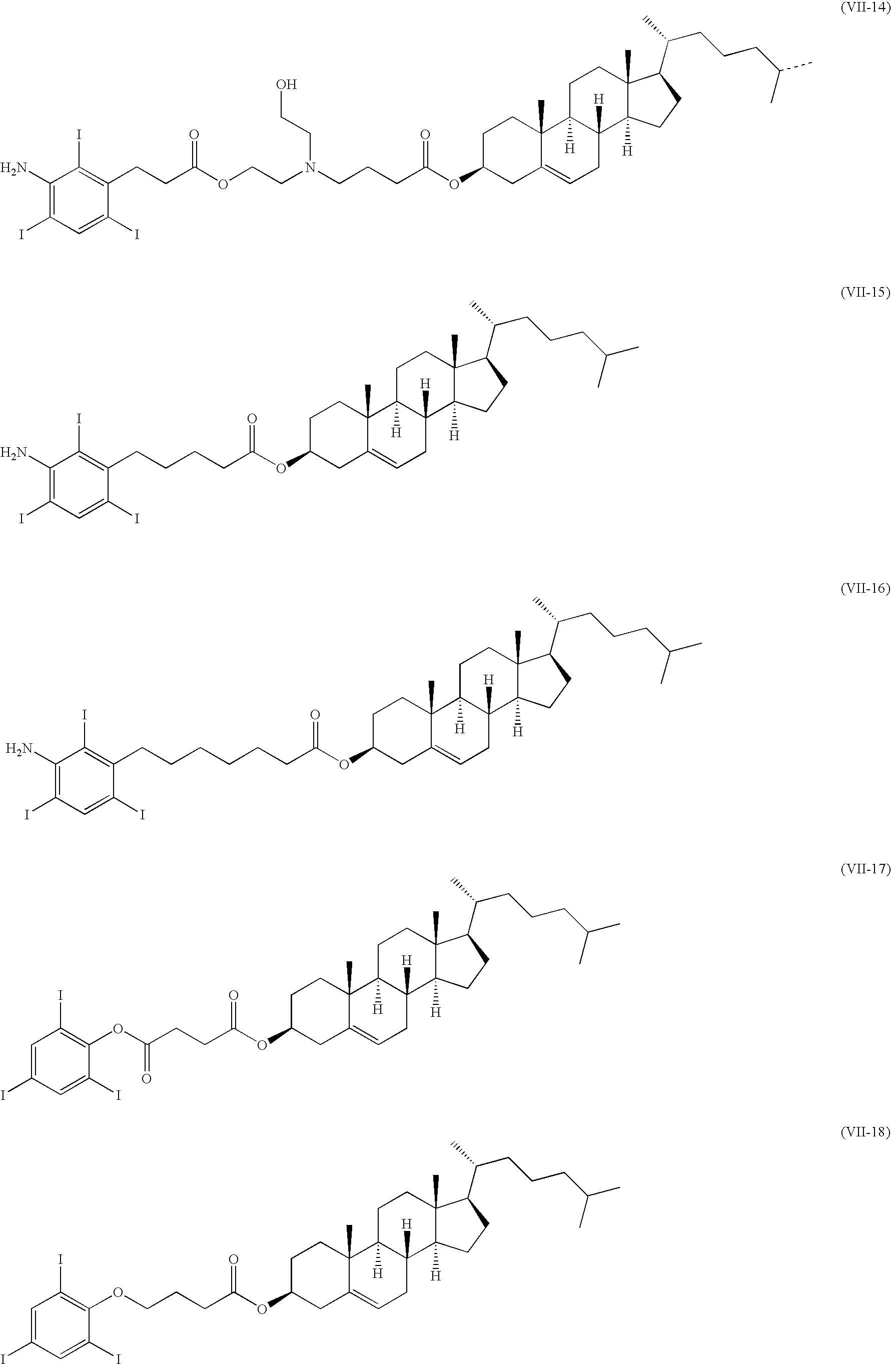

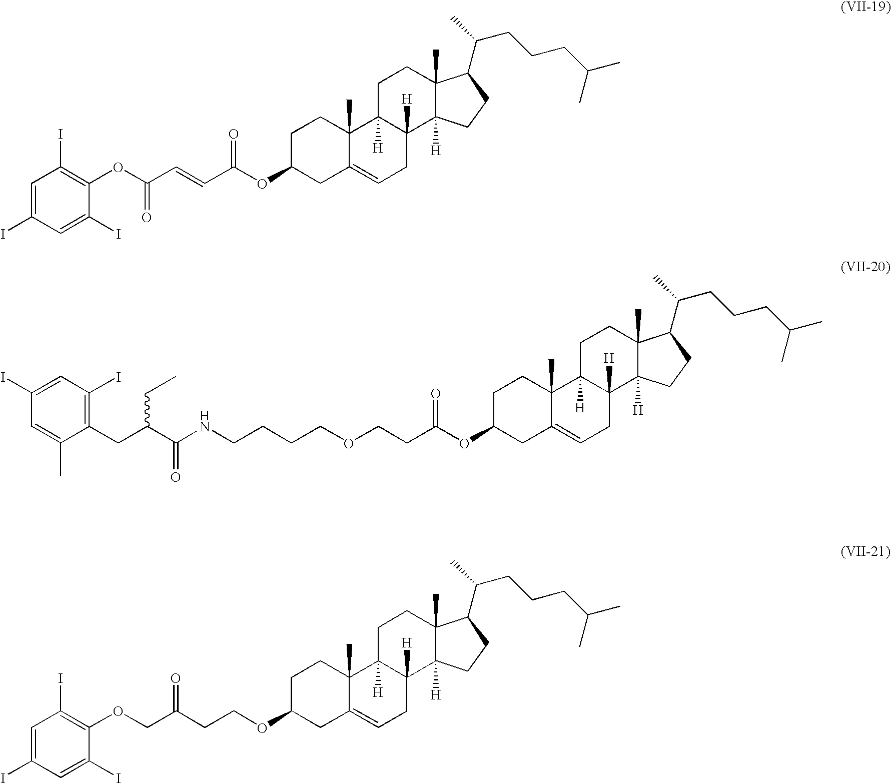

Further, as the hydrophobic iodine compound, a compound, which contains a steroid residue and two to six triiodophenyl groups, may be employed. In such cases, the compound should preferably contain a steroid residue and two triiodophenyl groups.

Furthermore, as the hydrophobic iodine compound, a compound, which may be represented by Formula (VII): 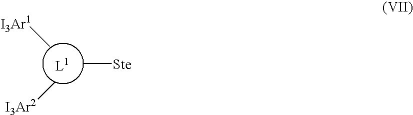
is preferable. In such cases, the trivalent connecting group L¹ should preferably be the group represented by Formula (VIII):

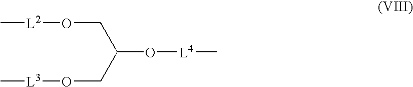

In the compound represented by Formula (VII), the group represented by “Ste” has the same meaning as the steroid residue described above. The group represented by “I₃Ar¹” and the group represented by “I₃Ar⁻” have the same meaning as the triiodophenyl group described above.

The trivalent connecting group, which is represented by L¹, contains one to 30 carbon atoms. The trivalent connecting group L¹ may be a saturated group. Alternatively, the trivalent connecting group L¹ may contain an unsaturated bond. Also, the trivalent connecting group L¹ may contain one hetero-atom or at least two hetero-atoms. Further, the trivalent connecting group L¹ may contain a functional group, which contains a hetero-atom, as a partial structure. Examples of the unsaturated moiety, which is contained in the connecting group, or the functional group containing a hetero-atom, which functional group is contained in the connecting group, include an alkenyl group (including a cycloalkenyl group and a bicycloalkenyl group), an alkynyl group, an aryl group, a heterocyclic group, an ester group (including a carboxylic acid ester group, a carbonic acid ester group, a sulfonic acid ester group, and a sulfinic acid ester group), an amido group (including a carboxylic acid amido group, a urethane group, a sulfonic acid amido group, and a sulfinic acid amido group), an ether group, a thioether group, a silyloxy group, a heterocyclic oxy group, an amino group (including an anilino group), an imido group, and a silyl group. The functional groups enumerated above may further have a substituent group. Also, a plurality of functional groups may be present in L¹. In cases where a plurality of functional groups are present in L¹, the plurality of the functional groups may be identical with one another or may be different from one another.

The partial structure of the trivalent connecting group, which is represented by L¹, should preferably be an alkenyl group, an alkynyl group, an aryl group, a heterocyclic group, an ester group, an amido group, an ether group, a urethane group, or an amino group. The partial structure of the trivalent connecting group, which is represented by L¹, should more preferably be an alkenyl group, an ester group, an amido group, or an ether group. It is also preferable that the trivalent connecting group, which is represented by L¹, is an unsaturated hydrocarbon group. The number of the carbon atoms contained in L¹ should preferably fall within the range of one to 25, and should more preferably fall within the range of one to 15. Also, L¹ may optionally have a substituent group. By way of example, the substituent group should preferably be an alkyl group, a cyano group, a hydroxyl group, a nitro group, a carboxyl group, an alkoxy group, an amino group, an acylamino group, an acyl group, or a carbamoyl group. The substituent group should more preferably be an alkyl group. It is also preferable that L¹ is an unsubstituted group.

The compound represented by Formula (VII) should particularly preferably be such that L¹ is a group represented by Formula (VIII) shown above. In Formula (VIII), each of L², L³, and L⁴ independently represents a bivalent connecting group containing one to 27 carbon atoms. Also, each of L² L³, and L⁴ maybe a saturated or unsaturated group and may contain a functional group, which contains a hetero-atom, as a partial structure. Examples of the partial structures include the partial structures having been described above with respect to L¹. The total number of carbon atoms contained in L², L³, and L⁴ may fall within the range of one to 27, should preferably fall within the range of one to 22, and should more preferably fall within the range of one to 15.

As preferable examples of the compound described above, compounds (VIII-1) to (X-19) are shown below. However, the compound described above is not limited to those shown below.

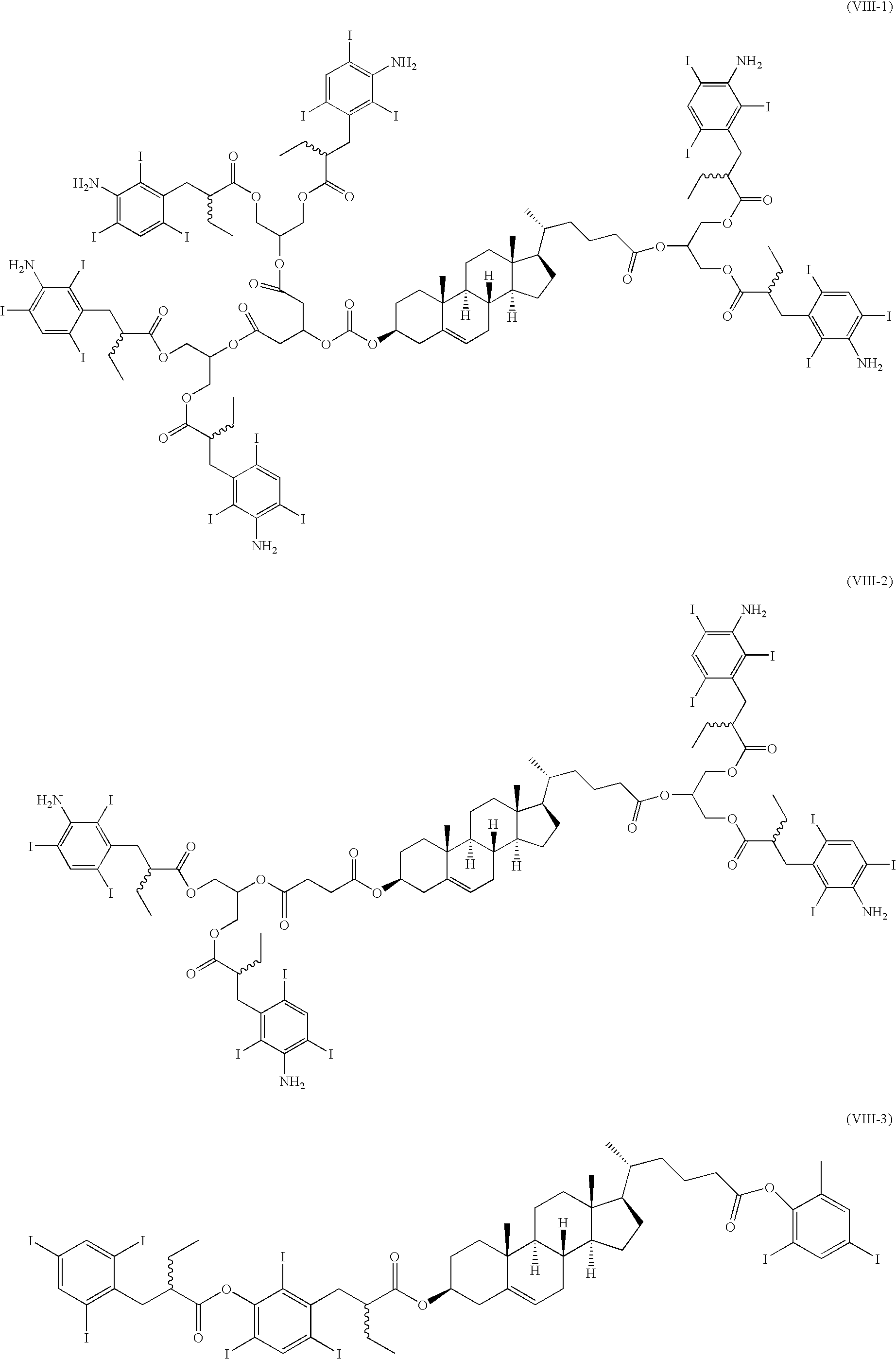

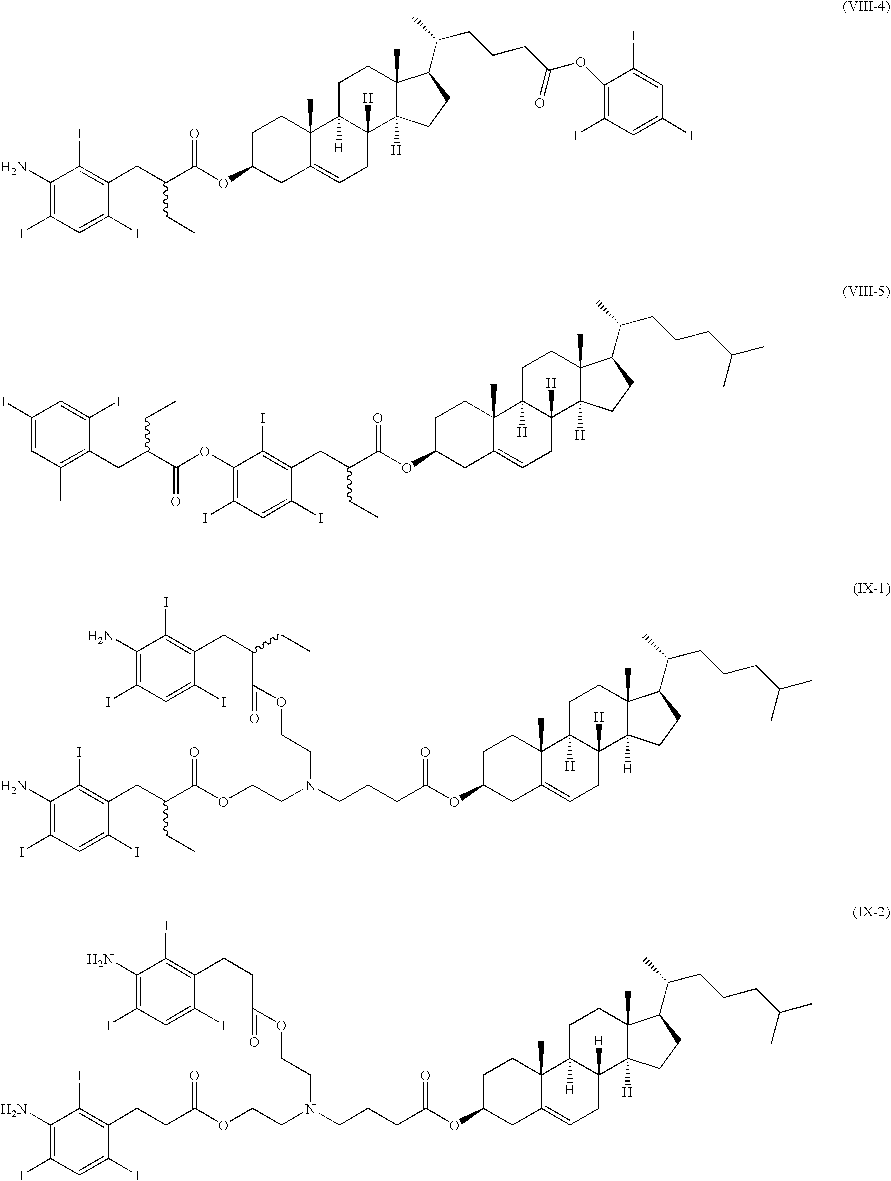

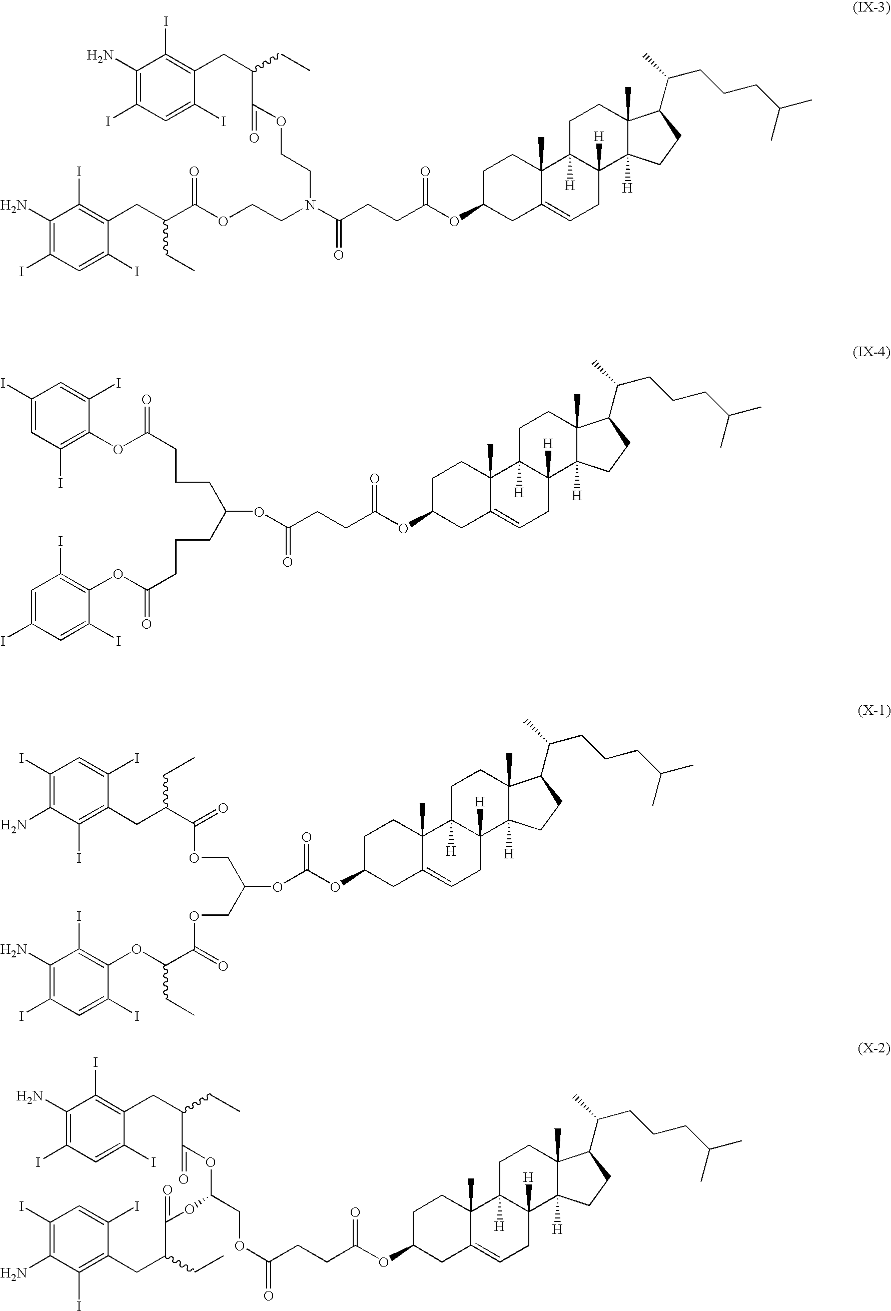

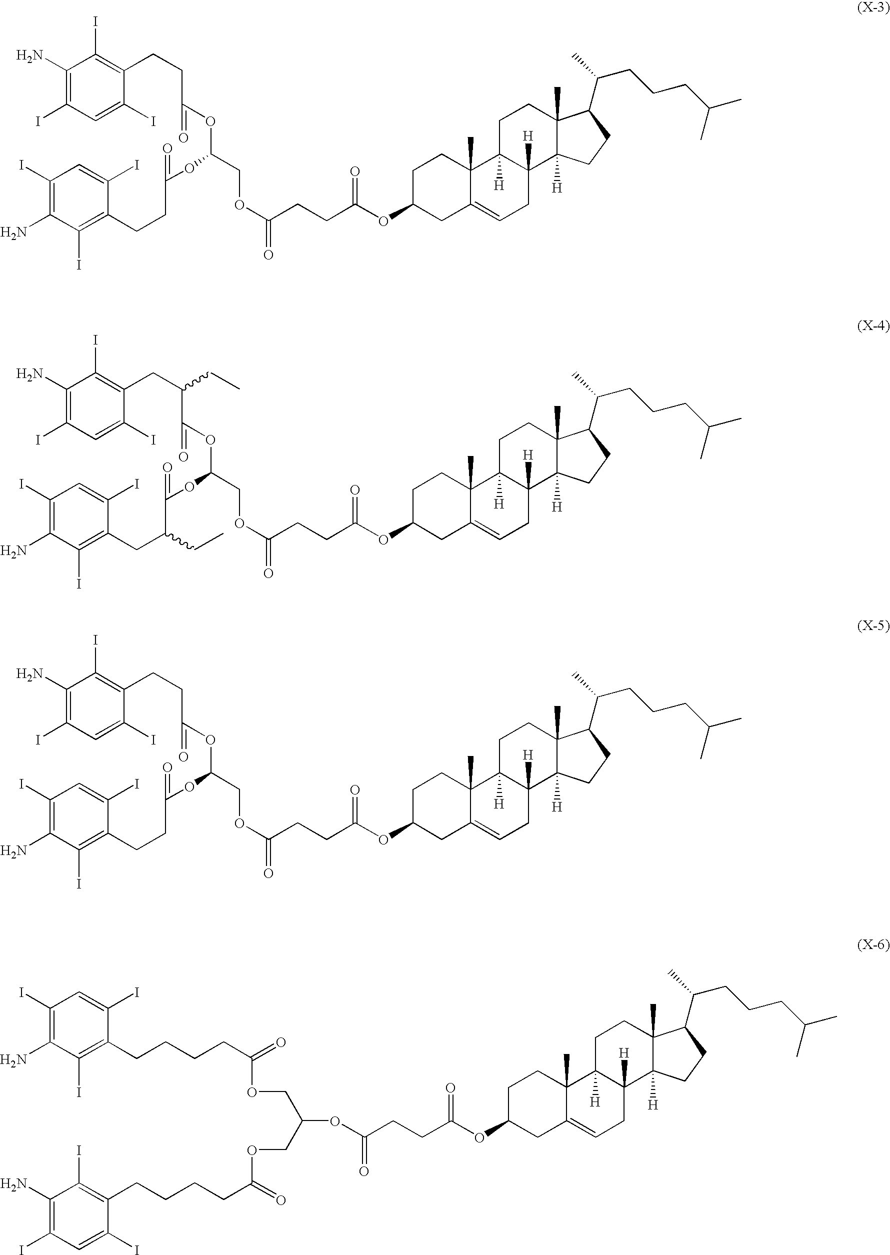

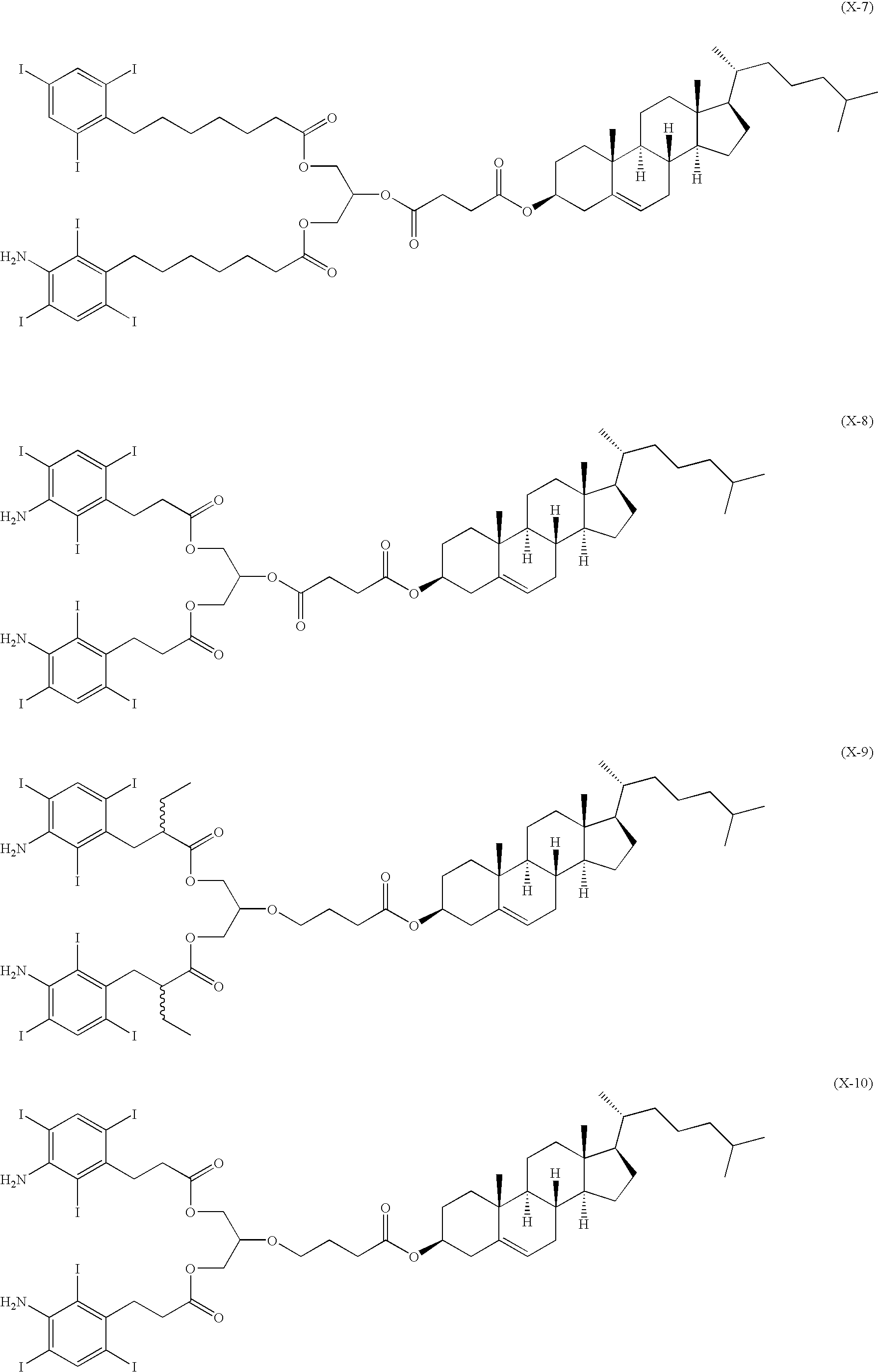

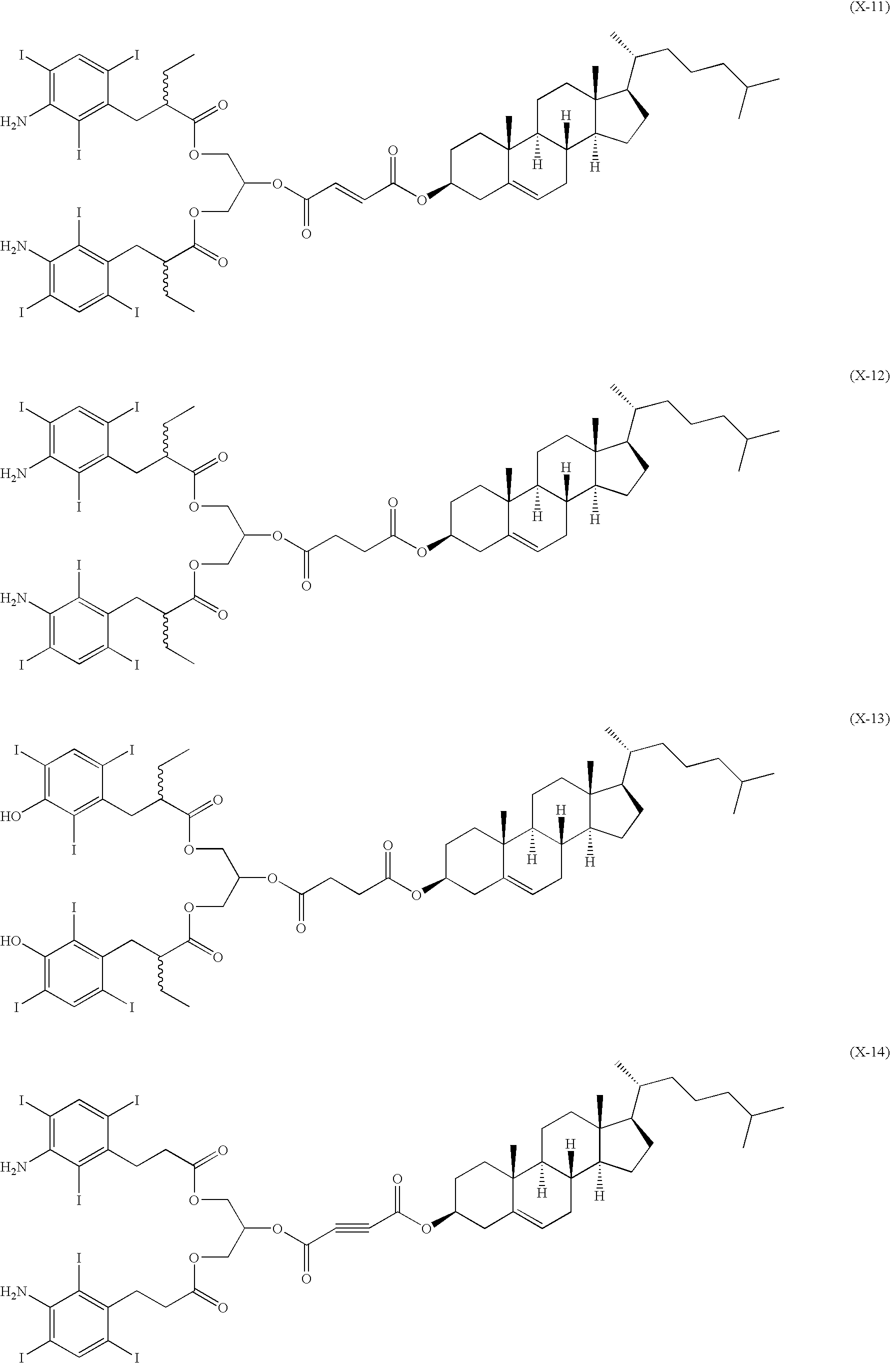

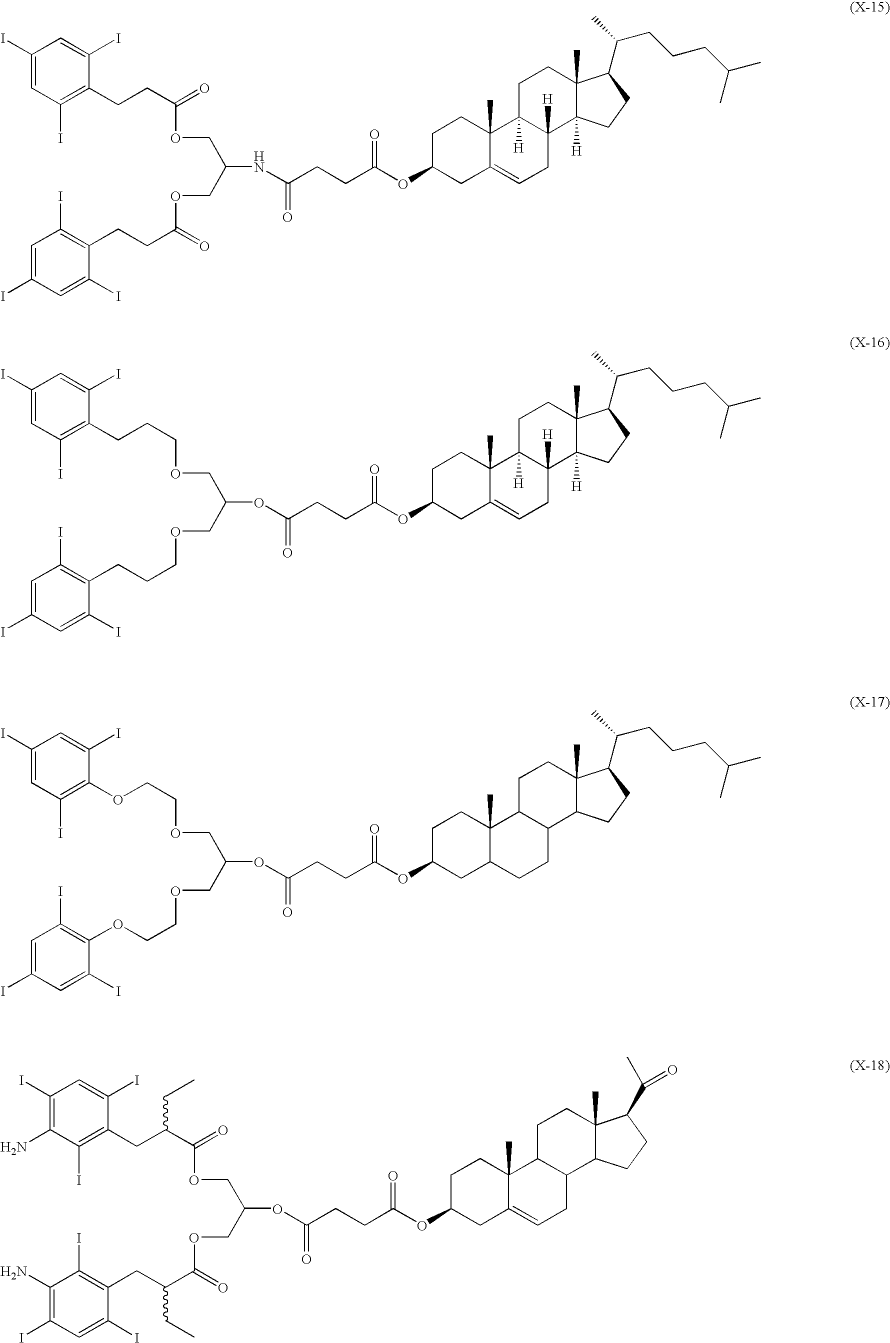

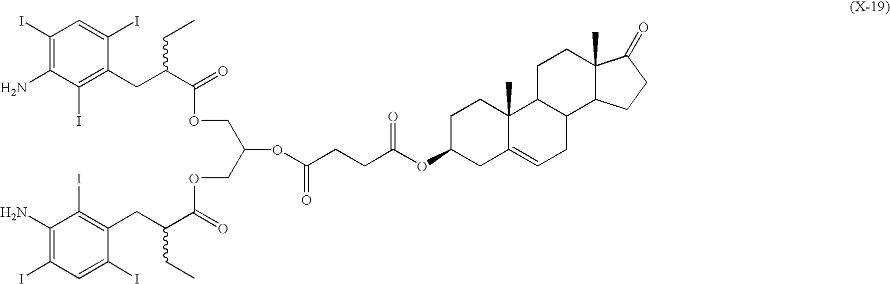

The hydrophobic iodine compound described above, which is employed as the film forming constituent of the liposome, may be utilized in a proportion falling within the range of approximately 10% by mass to approximately 90% by mass with respect to the total mass of film forming constituents, should preferably be utilized in a proportion falling within the range of approximately 10% by mass to approximately 80% by mass with respect to the total mass of film forming constituents, and should more preferably be utilized in a proportion falling within the range of approximately 20% by mass to approximately 80% by mass with respect to the total mass of film forming constituents. Only one kind of the hydrophobic iodine compound described above may be utilized as the film forming constituent. Alternatively, at least two kinds of the hydrophobic iodine compounds described above may be utilized in combination as the film forming constituents.

As other film forming constituents of the liposome, lipid compounds, which are ordinarily used for the production of liposomes, may be utilized. The lipid compounds, which are ordinarily used for the production of liposomes, are described in, for example, Biochim. Biophys. Acta, 150(4), 44 (1982); Adv. in Lipid. Res., 16(1), 1 (1978); “Research in Liposomes” (by P. Machy and L. Leserman, John Libbey EUROTEXT Company); and “Liposome” (by Nojima, Sunamoto, and Inoue, Nankodo) The lipid compounds should preferably be phospholipids, and should more preferably be phosphatidyl cholines (PC). Preferable examples of the phosphatidyl cholines include egg PC, dimyristoyl PC (DMPC), dipalmitoyl PC (DPPC), distearoyl PC (DSPC), and dioleyl PC (DOPC) However, the lipid compounds are not limited to the compounds enumerated above.

Also, as the film forming constituents of the liposome, a phosphatidyl choline and a phosphatidyl serine (PS) may be utilized in combination. Examples of the phosphatidyl serines include the compounds, which have the same lipid sites as the lipid sites of the phospholipids having been enumerated above as the preferable examples of the phosphatidyl cholines. In cases where the phosphatidyl choline (PC) and the phosphatidyl serine (PS) are utilized in combination, the molar ratio of PC to PS should preferably fall between PC: PS=90:l0 and PC:PS=l0:90, and should more preferably fall between PC:PS=30:70 and PC:PS=70:30.

A different example of the liposome is a liposome, which contains a phosphatidyl choline, a phosphatidyl serine, and a phosphoric acid dialkyl ester. The two alkyl groups, which constitute the dialkyl ester moiety of the phosphoric acid dialkyl ester, should preferably be identical with each other. Also, each of the two alkyl groups may have at least six carbon atoms, should preferably have at least 10 carbon atoms, and should more preferably have at least 12 carbon atoms. Examples of preferable phosphoric acid dialkyl esters include dilauryl phosphate, dimyristyl phosphate, and dicetyl phosphate. However, the phosphoric acid dialkyl ester is not limited to those enumerated above. The proportion of the mass of the phosphoric acid dialkyl ester with respect to the total mass of the phosphatidyl choline and the phosphatidyl serine may fall within the range of 1% by mass to 50% by mass, shouldpreferably fall within the range of 1% bymass to 30% by mass, and should more preferably fall within the range of 1% by mass to 20% by mass.

In cases where the liposome contains the phosphatidyl choline (PC), the phosphatidyl serine (PS), the phosphoric acid dialkyl ester, and the hydrophobic iodine compound as the film forming constituents, the mass ratio of PC:PS:phosphoric acid dialkyl ester:hydrophobic iodine compound may be selected from the range of (5% by mass to 40% by mass): (5% by mass to 40%. by mass): (1% by mass to 10% by mass): (15% by mass to 80% by mass).

The constituents of the liposome, which is employed as the contrast medium in the method of forming a subtraction image in accordance with the present invention, is not limited to the four kinds of the constituents described above and may include other constituents. In such cases, examples of the other constituents include cholesterol; a cholesterol ester; sphingomyelin; monocyano-ganglioside GM1 derivatives described in, for example, FEBS Lett. 223, 42 (1987), and Proc. Natl. Acad. Sci., USA, 85, 6949 (1988); glucuronic acid derivatives described in, for example, Chem. Lett., 2145 (1989), and Biochim. Biophys. Acta, 1148, 77 (1992); and polyethylene glycol derivatives described in, for example, Biochim. Biophys. Acta, 1029, 91 (1990), and FEBS Lett., 268, 235 (1990). However, the other constituents are not limited to those enumerated above.

The liposome utilized as the contrast medium is capable of being prepared with one of various techniques which are known in the art. The techniques for preparing the liposome are described in, for example, various literature concerning the liposomes; Ann. Rev. Biophys. Bioeng., 9, 467 (1980); and “liposomes” by M. J. Ostro, MARCELL DEKKER, INC. Examples of the techniques for preparing the liposome include an ultrasonic processing technique, an ethanol injection technique, a French press technique, an ether injection technique, a cholic acid technique, a calcium fusion technique, a freeze-thaw technique, and a reversed-phase evaporation technique. However, the techniques for preparing the liposome are not limited to those enumerated above. The liposome may be of any size, which is capable of being obtained with the aforesaid techniques for preparing the liposome ordinarily, the mean size of the liposome is at most 400 nm, and should preferably be at most 200 nm. No limitation is imposed upon the structure of the liposome, and the liposome may be of, for example, a uni-lamella structure or a multi-lamella structure. Also, at least one kind of an appropriate medical substance and at least one of other contrast media may be contained within the liposome.

In cases where the liposome is utilized as the contrast medium, the liposome should preferably be administered parenterally, and should more preferably be administered intravenously. For example, a preparation in the form of an injection or drops may be furnished as a powder composition in a lyophilized form. At the time at which the preparation is to be used, the preparation may be used by being dissolved or re-suspended in water or a different appropriate medium (e.g., a physiological saline, a glucose transport liquid, or a buffer). In cases where the liposome is used as the contrast medium, the dosage of the liposome may be determined appropriately such that the iodine content in the liposome may become approximately identical with the iodine content of the conventional hydrophobic iodine contrast medium.

1. A method of forming a subtraction image, comprising the steps of:
i) acquiring a radiation image signal from a radiation image of an object before being injected with a contrast medium, the radiation image signal being made up of a series of image signal components,
ii) acquiring a radiation image signal from a radiation image of the same object after being injected with the contrast medium, the radiation image signal being made up of a series of image signal components, and
iii) performing a subtraction process for subtracting the image signal components of a plurality of the thus acquired radiation image signals, which image signal components represent corresponding pixels in the radiation images represented by the plurality of the radiation image signals, from one another, whereby a contrasted radiation image, in which a pattern of a specific structure of the object having been contrasted with the contrast medium in the radiation image has been extracted or enhanced, is formed,
wherein the contrast medium is a liposome, which contains a hydrophobic iodine compound as a film forming constituent.

2. A method as defined in claim 1 wherein the hydrophobic iodine compound is a 1,3,5-triiodobenzene derivative having at least one substituent group having at least 18 carbon atoms.

3. A method as defined in claim 1 wherein the liposome contains at least one lipid, which is selected from the group consisting of a phosphatidyl choline and a phosphatidyl serine, as a film forming constituent.

4. A method as defined in claim 2 wherein the liposome contains at least one lipid, which is selected from the group consisting of a phosphatidyl choline and a phosphatidyl serine, as a film forming constituent.

5. A method as defined in claim 1 wherein the liposome contains a phosphoric acid dialkyl ester, which is a diester of an alkyl having at least six carbon atoms, as a film forming constituent.

6. A method as defined in claim 2 wherein the liposome contains a phosphoric acid dialkyl ester, which is a diester of an alkyl having at least six carbon atoms, as a film forming constituent.

7. A method as defined in claim 3 wherein the liposome contains a phosphoric acid dialkyl ester, which is a diester of an alkyl having at least six carbon atoms, as a film forming constituent.

8. A method as defined in claim 4 wherein the liposome contains a phosphoric acid dialkyl ester, which is a diester of an alkyl having at least six carbon atoms, as a film forming constituent.

9. A method as defined in claim 1 wherein the hydrophobic iodine compound has a residue of a cholesterol derivative as a substituent group having at least 18 carbon atoms.

10. A method as defined in claim 2 wherein the hydrophobic iodine compound has a residue of a cholesterol derivative as a substituent group having at least 18 carbon atoms.

11. A method as defined in claim 3 wherein the hydrophobic iodine compound has a residue of a cholesterol derivative as a substituent group having at least 18 carbon atoms.

12. A method as defined in claim 4 wherein the hydrophobic iodine compound has a residue of a cholesterol derivative as a substituent group having at least 18 carbon atoms.

13. A method as defined in claim 5 wherein the hydrophobic iodine compound has a residue of a cholesterol derivative as a substituent group having at least 18 carbon atoms.

14. A method as defined in claim 6 wherein the hydrophobic iodine compound has a residue of a cholesterol derivative as a substituent group having at least 18 carbon atoms.

15. A method as defined in claim 7 wherein the hydrophobic iodine compound has a residue of a cholesterol derivative as a substituent group having at least 18 carbon atoms.

16. A method as defined in claim 8 wherein the hydrophobic iodine compound has a residue of a cholesterol derivative as a substituent group having at least 18 carbon atoms.
